(19) United States
(12) Patent Application Publication
(10) Pub. No.: US 2012/0179641 A1
(43) Pub. Date: Jul. 12, 2012

(54) CONTENT CLASSIFICATION SYSTEM, CONTENT GENERATION CLASSIFICATION DEVICE, CONTENT CLASSIFICATION DEVICE, CLASSIFICATION METHOD, AND PROGRAM

(76) Inventor: Toshiyuki Ishioka, Osaka (JP)

(21) Appl. No.: 13/144,155

(22) PCT Filed: Feb. 4, 2011
(86) PCT No.: PCT/JP2011/000630

§ 371 Date: Jul. 12, 2011

(30) Foreign Application Priority Data
May 31, 2010 (JP) 2010-123798

(51) Int. Cl. G06N 5/02

(52) U.S. Cl. 706/54

(57) ABSTRACT

A content classification system provided with a content generating device for generating contents in sequence, the content classification system comprising: a detection unit operable to repeatedly detect a state of the content generating device, the state being a first state in which the content generating device is present at a predetermined position, or a second state in which the content generating device is not present at the predetermined position; and a classification unit operable to perform a classification process to classify two contents into different groups when there is a change in the state detected by the detection unit during a period between generations of the two contents by the content generating device, and classify the two contents into a same group when there is no change in the state detected by the detection unit during the period.

### TECHNICAL FIELD

The present invention relates to a technology for classifying generated contents.

### BACKGROUND ART

There is known a technology for classifying contents, such as image data, for each date on which the contents were generated. This method, however, has a problem that contents generated in one event (such as a trip) that extend over a plurality of days and thus are highly related to each other are classified into different groups.

Solutions to this problem have been proposed by, for example, Patent literatures 1-3.

The technology of Patent Literature 1 is to classify images captured in continuous days into one group. The technology of Patent Literature 2 is to set, as a separator, a position at a great change in the interval between image capturing dates/times, and classify images captured before and after the separator into different groups.

The technology of Patent Literature 3 is to originally store a piece of GPS (Global Positioning System) information that indicates a latitude and a longitude of an image capturing position for each piece of image data, set a reference position to, for example, a home of the user, and classify images into groups depending on whether or not a distance between an image capturing position and the reference position is larger than a predetermined distance.

### CITATION LIST

### Patent Literature

### [Patent Literature 1]

Japanese Patent Publication No. 2002-112165

### [Patent Literature 2]

Japanese Patent Publication No. 2008-269009

### [Patent Literature 3]

Japanese Patent Publication No. 2004-120486

### SUMMARY OF INVENTION

### Technical Problem

However, there is a problem common to all of the above methods of Patent Literatures 1-3. The problem is that images captured in different events might be classified into one group.

For example, a user may participate in an event A performed near his/her home in the morning, and may participate in an event B performed in his/her home in the afternoon of the day. In that case, the images captured in the event A and the event B would be classified into one group.

It is therefore an object of the present invention to provide a content classification system having an increased possibility to classify a plurality of generated contents into events appropriately.

### Solution to Problem

The above object is fulfilled by a content classification system provided with a content generating device for generating contents in sequence, the content classification system comprising: a detection unit operable to repeatedly detect a state of the content generating device, the state being a first state in which the content generating device is present at a predetermined position, or a second state in which the content generating device is not present at the predetermined position; and a classification unit operable to perform a classification process to classify two contents into different groups when there is a change in the state detected by the detection unit during a period between generations of the two contents by the content generating device, and classify the two contents into a same group when there is no change in the state detected by the detection unit during the period.

### Advantageous Effects of Invention

With the above structure of the content classification system of the present invention, it is possible to increase the possibility to classify a plurality of generated contents into events appropriately.

### BRIEF DESCRIPTION OF DRAWINGS

FIG. 1 is a block diagram illustrating the functional structure of the main parts of the digital camera 100 in Embodiment 1.

FIG. 2 illustrates an example of a data structure and contents of the image information table 10 used by the digital camera 100.

FIG. 3 is a flowchart showing the processing procedure of updating the exiting and entering date/time information performed by the time information update unit 119.

FIG. 4 is a flowchart showing a classification process performed by the classification processing unit 120.

FIG. 5 illustrates an example of timings at which a plurality of pieces of image data are generated and timings at which the state of the digital camera 100 changes.

FIGS. 6A through 6D illustrate how the exiting date/time information and the entering date/time information are updated.

FIGS. 7A through 7C illustrate how the image information table 10 is updated.

FIGS. 8A and 8B illustrate how the image information table 10 is updated.

FIGS. 9A and 9B illustrate display examples of classification results.

FIG. 10 is a block diagram illustrating a system structure of the content classification system 1000 in Embodiment 2.

FIGS. 11A and 11B illustrate an example of the data structure and contents of an exiting date/time table 20 and entering date/time table 30.

FIG. 12 is a flowchart showing a classification process performed by the classification processing unit 308.

FIG. 13 is a block diagram illustrating a system structure of the content classification system 1100 in Modification 1.

FIG. 14 is a block diagram illustrating a system structure of the content classification system 1200 in Modification 2.

### DESCRIPTION OF EMBODIMENTS

The following describes embodiments of the present invention with reference to the drawings.

### Embodiment 1

Embodiment 1 describes a digital camera 100 including a content generation classification device 110 as one embodiment of a content generation classification device of the present invention.

### <Structure>

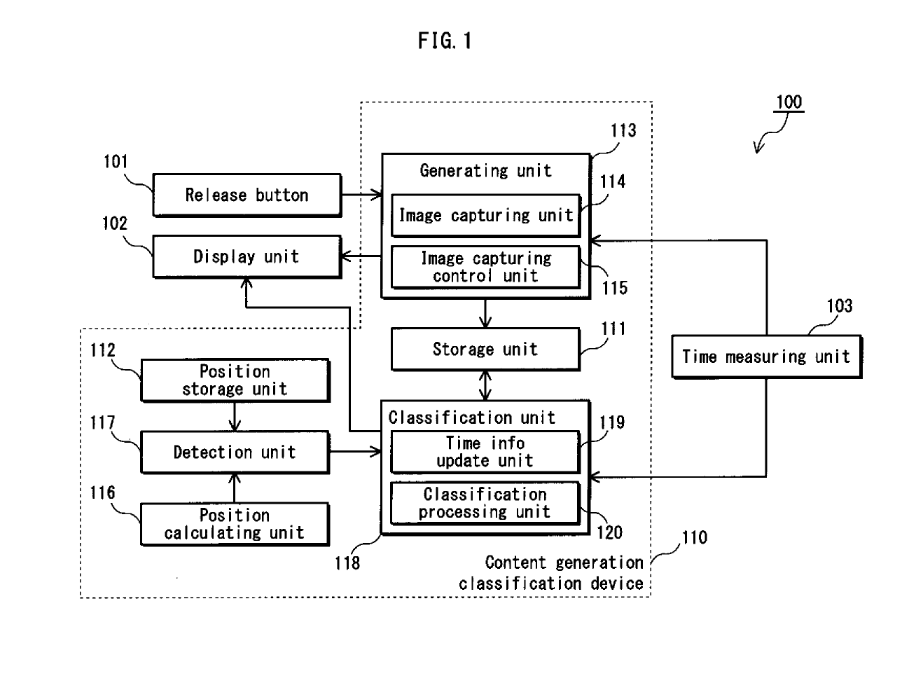

First, the structure of the digital camera 100 including the content generation classification device 110 in the present embodiment will be described with reference to FIG. 1.

FIG. 1 is a block diagram illustrating the functional structure of the main parts of the digital camera 100 in Embodiment 1.

As shown in FIG. 1, the digital camera 100 includes a release button 101, a display unit 102, a time measuring unit 103, and the content generation classification device 110.

The release button 101 is used for the user to instruct an image capturing, and has a function to transmit a predetermined input signal to the content generation classification device 110 after the button is depressed by the user.

The display unit 102 includes an LCD (Liquid Crystal Display), and has a function to display a captured image or the like in accordance with an instruction received from the content generation classification device 110.

The time measuring unit 103 is what is called a clock, and has a function to keep measuring the current date and time.

The content generation classification device 110 has a function to classify, into event periods, image data having been generated when images were captured based on input signals from the release button 101. The content generation classification device 110 includes a storage unit 111, a position storage unit 112, a generating unit 113, a position calculating unit 116, a detection unit 117, and a classification unit 118.

Here, the event period refers to a period in which either a state in which the digital camera 100 is present at a predetermined position, or a state in which the digital camera 100 is not present at the predetermined position, continues. In the present embodiment, the predetermined position is presumed to be a home of the user of the digital camera 100.

There is a high possibility in general that the user with the digital camera 100 enters or exits the home between participations in two consecutive events (a trip, a sports meet, a party and the like).

The content generation classification device 110 classifies image data into event periods, thereby increasing the possibility that the generated image data is classified into events.

Note that the content generation classification device 110 includes a processor and a memory, and the functions of the generating unit 113, position calculating unit 116, detection unit 117, and classification unit 118 are realized as the processor executes a program stored in the memory.

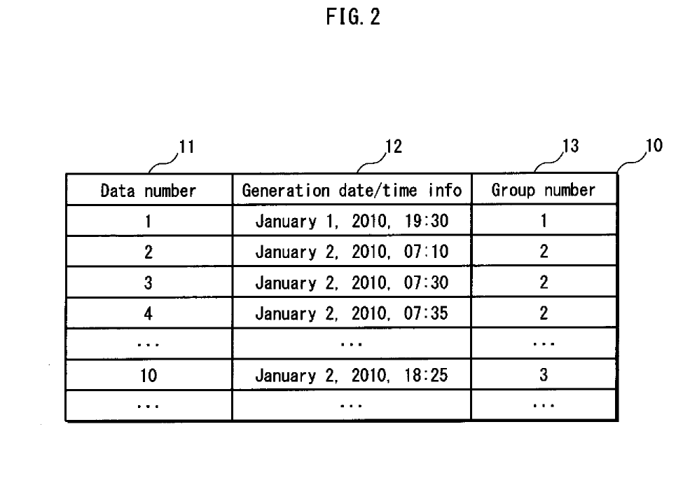

The storage unit 111 is realized by a recording medium such as a memory or a hard disk, and has a function to store the generated image data, an image information table 10 (see FIG. 2) which will be described later, and the like.

The position storage unit 112 is realized by a recording medium such as a memory or a hard disk, and has a function to store information (hereinafter referred to as “positional information”) indicating a latitude and a longitude of the predetermined position (in the present example, the home of the user of the digital camera 100).

The generating unit 113 has a function to store, into the storage unit 111, (i) image data having been generated when images were captured based on input signals from the release button 101, and (ii) information (hereinafter referred to as “generation date/time information”) indicating dates and times at which the image data were generated. The generating unit 113 includes an image capturing unit 114 and an image capturing control unit 115.

Here, the image capturing unit 114 includes a lens, a CCD (Charge Couple Device), and an A/D (Analog to Digital) conversion unit, and transmits, to the image capturing control unit 115, image data (for example, a set of luminance data for 640×480 pixels) having been generated when images were captured in accordance with instructions from the image capturing control unit 115. The image data is generated through the following processes: light beams incident from the subject are concentrated on the CCD by a lense; the light is converted into an electric signal by the CCD; and the electric signal is converted into a digital signal by the A/D converter.

The image capturing control unit 115 has a function to instruct the image capturing unit 114 to capture an image upon receiving an input signal from the release button 101, and store, into the storage unit 111, (i) image data received from the image capturing unit 114, and (ii) generation date/time information indicating the date and time obtained from the time measuring unit 103.

The image capturing control unit 115 stores image data and identification information of the image data (hereinafter referred to as “data number”) in association with each other into the storage unit 111, and registers, in the image information table 10 stored in the storage unit 111, the generation date/time information and the data number in association with each other. As a result of this, the image data is associated with the generation date/time information via the data number.

It is presumed in the following that the data numbers are assigned as serial numbers in an order of generation of image data, starting with “1” as the initial value at the beginning of the use of the digital camera 100.

The position calculating unit 116 includes a GPS antenna, and has a function to calculate repeatedly a latitude and a longitude of a location of the digital camera 100 based on signals received from a GPS satellite via the GPS antenna.

The detection unit 117 has a function to repeatedly detect whether the digital camera 100 is within the home (first state) or not (second state), based on the position information stored in the position storage unit 112 and the result of calculation performed by the position calculating unit 116.

The detection unit 117 detects the first state when a difference between (i) the latitude and longitude of the home of the user of the digital camera 100 indicated by the position information and (ii) the latitude and longitude of the position of the digital camera 100 calculated by the position calculating unit 116, is equal to or less than a predetermined value (for example, one second), and detects the second state when the difference is more than the predetermined value, and sends the result of the detection to the classification unit 118.

The classification unit 118 has a function to classify image data stored in the storage unit 111 into event periods, based on the result of the detection received from the detection unit 117. The classification unit 118 includes a time information update unit 119 and a classification processing unit 120. The classification unit 118 also has a function to display thumbnails of image data on the display unit 102 based on the classification result, upon receiving a predetermined user operation from an operation unit (not illustrated).

The time information update unit 119 has a function to, upon receiving a detection result from the detection unit 117, update exiting date/time information or entering date/time information depending on the change between the states indicated by the current and previous detection results. It is presumed in the present example that the exiting date/time information and the entering date/time information are stored in the storage unit 111.

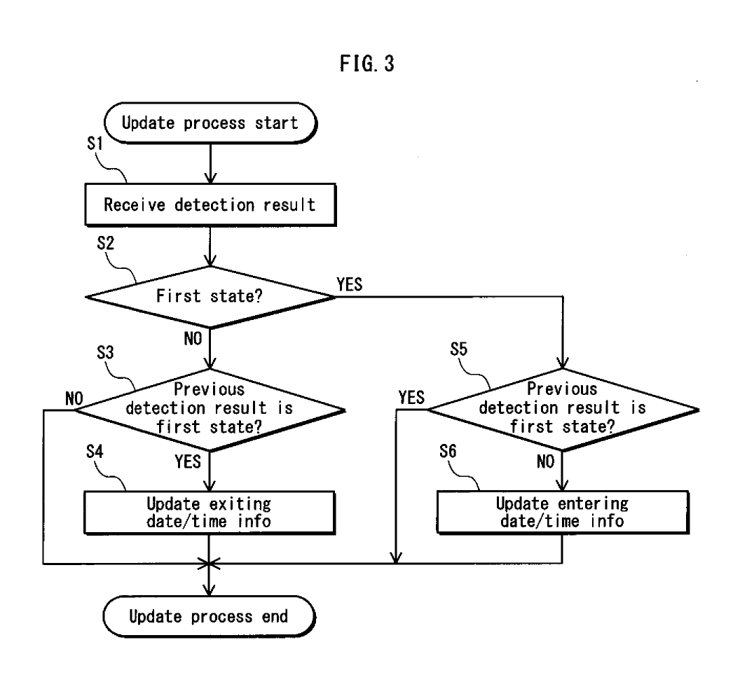

The exiting date/time information is information indicating the date and time at which it was detected that the digital camera 100 had exited the home; and the entering date/time information is information indicating the date and time at which it was detected that the digital camera 100 had entered the home. A method for updating the exiting date/time information and the entering date/time information will be described later (see FIG. 3).

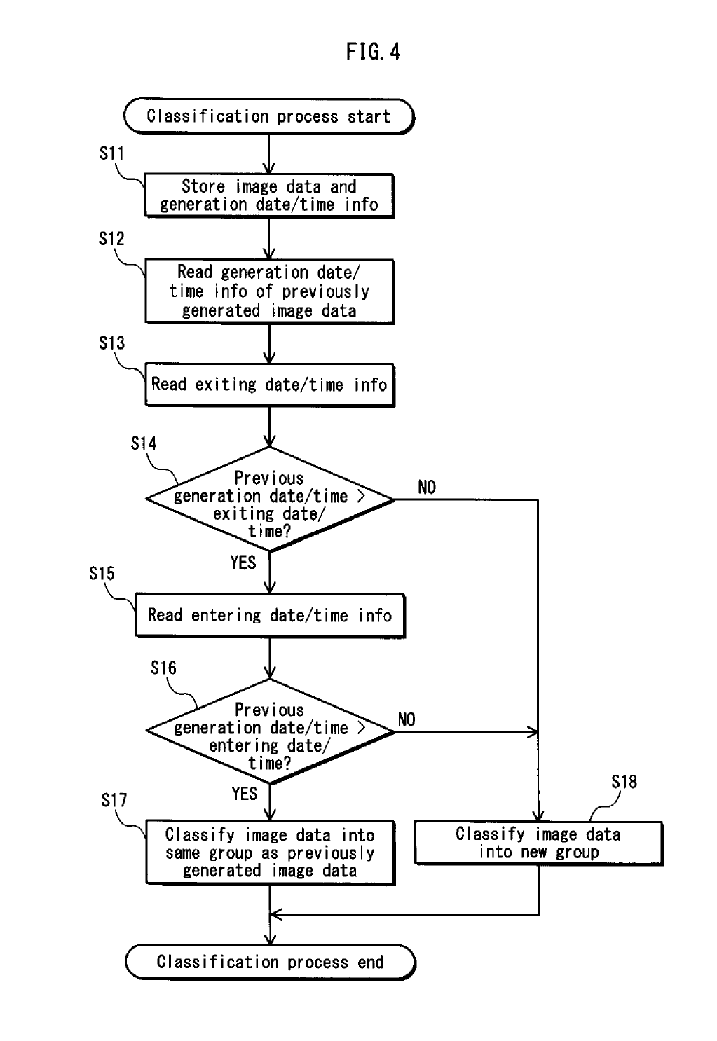

The classification processing unit 120 has a function to classify, into event periods, image data that was newly stored into the storage unit 111, based on the exiting date/time information and the entering date/time information stored in the storage unit 111 and the generation date/time information of the previously stored image data registered in the image information table 10. This classification method will be described later (see FIG. 4).

### <Data>

Next, data used by the digital camera 100 will be described with reference to FIG. 2.

FIG. 2 illustrates an example of a data structure and contents of the image information table 10 used by the digital camera 100.

As shown in FIG. 2, the image information table 10 includes, for each piece of image data, a data number 11, generation date/time information 12, and a group number 13 in association with each other.

The data number 11 is identification information of an associated piece of image data. In the present example, data numbers are assigned as serial numbers in an order of generation of image data, starting with “1” as the initial value at the beginning of the use of the digital camera 100.

The generation date/time information 12 is data indicating a generation date and time of an associated piece of image data. The group number 13 is identification information of a group into which an associated piece of image data has been classified. In the present example, group numbers are assigned as serial numbers, starting with “1” as the initial value at the beginning of the use of the digital camera 100.

FIG. 2 indicates, for example, that, with regard to a piece of image data whose data number is “1”, the generation date/time is “January 1, 2010, 19:30”, and the group number of a group to which the piece of image data has been classified is

FIG. 2 also indicates, for example, that image data whose data numbers are “2”-“4” have been classified into the same group with a group number “2”, indicating that these image data were generated, along with capturing of associated images, in the same event period.

FIG. 2 also indicates that the piece of image data whose data number is “1” has been classified into a group that is different from the group into which the image data whose data numbers are “2”-“4” have been classified, indicating that they were generated, along with capturing of associated images, in different event periods.

The image information table 10 is updated at the timing when the generating unit 113 generates image data, and is referenced and updated at the timing when the classification unit 118 classifies image data.

### <Operation>

Next, an operation of the digital camera 100 will be described with reference to FIGS. 3 and 4.

### <Update Process>

FIG. 3 is a flowchart showing the processing procedure of updating the exiting and entering date/time information performed by the time information update unit 119.

Upon receiving a detection result from the detection unit 117 (step S1), the time information update unit 119 obtains a current date and time from the time measuring unit 103, and judges whether or not the received detection result indicates the first state (step S2).

If the received detection result indicates the second state (step S2: NO), the time information update unit 119 judges whether or not a detection result previously received from the detection unit 117 indicates the first state (step S3). If the previously received detection result indicates the second state (step S3: NO), the update process is ended without updating any of the exiting date/time information and the entering date/time information.

This is because both of the detection results indicate the second state, and it can be determined that the user with the digital camera 100 is out of the home at this point in time.

If the previously received detection result indicates the first state (step S3: YES), the time information update unit 119 updates the exiting date/time information stored in the storage unit 111 to indicate a date and time obtained from the time measuring unit 103 (step S4), and ends the update process.

The exiting date/time information is updated in step S4 because the state has changed from the first state to the second state, and it can be determined that the user with the digital camera 100 has exited the home.

On the other hand, if the received detection result indicates the first state (step S2: YES), the time information update unit 119 judges whether or not a detection result previously received from the detection unit 117 indicates the first state (step S5). If the previously received detection result indicates the first state (step S5: YES), the update process is ended without updating any of the exiting date/time information and the entering date/time information.

This is because both of the detection results indicate the first state, and it can be determined that the user with the digital camera 100 is in the home at this point in time.

If the previously received detection result indicates the second state (step S5: NO), the time information update unit 119 updates the entering date/time information stored in the storage unit 111 to indicate a date and time obtained from the time measuring unit 103 (step S6), and ends the update process.

The entering date/time information is updated in step S6 because the state has changed from the second state to the first state, and it can be determined that the user with the digital camera 100 has entered the home.

### <Classification Process>

FIG. 4 is a flowchart showing a classification process performed by the classification processing unit 120.

The image capturing control unit 115 stores image data generated by the image capturing unit 114 and generation date/time information into the storage unit 111 in association with each other (step S11). That is to say, image data generated by the image capturing unit 114 is stored into the storage unit 111 in association with a data number thereof, and the data number and generation date/time information are registered in the image information table 10.

After the process of step S11 is performed, the classification processing unit 120 reads, from the image information table 10, generation date/time information of the previously generated image data, namely, generation date/time information associated with a data number that is obtained by reducing “1” from the latest data number (step S 12), and reads exiting date/time information from the storage unit 111 (step S13).

The classification processing unit 120 judges whether a generation date/time indicated by the generation date/time information read in step S12, namely a generation date/time of the previously generated image data, is later than an exiting date/time indicated by the exiting date/time information read in step S13 (step S14). If it is judged that the generation date/time of the previously generated image data is later than the exiting date/time (step S14: YES), the classification processing unit 120 reads entering date/time information from the storage unit 111 (step S15).

The classification processing unit 120 judges whether the generation date/time indicated by the generation date/time information read in step S12, namely the generation date/time of the previously generated image data, is later than an entering date/time indicated by the entering date/time information read in step S15 (step S16). If it is judged that the generation date/time of the previously generated image data is later than the entering date/time (step S16: YES), the classification processing unit 120 classifies image data, that is generated this time and stored into the storage unit 111, into the same group as the previously generated image data (step S17), and ends the classification process.

More specifically, in the process of step S17, the group number of the previously generated image data is registered in the image information table 10 as a group number associated with the latest data number.

If it is judged that the generation date/time of the previously generated image data is earlier than the exiting date/time (step S14: NO), or if it is judged that the generation date/time of the previously generated image data is earlier than the entering date/time (step S16: NO), the classification processing unit 120 classifies image data, that was generated this time and stored into the storage unit 111 in step S11, into a new group which is different from the group into which the previously generated image data has been classified (step S18), and ends the classification process.

More specifically, in the process of step S18, a value obtained by adding “1” to the group number of the previously generated image data is registered in the image information table 10 as a group number associated with the latest data number.

<Explanation of Operation with Concrete Example>

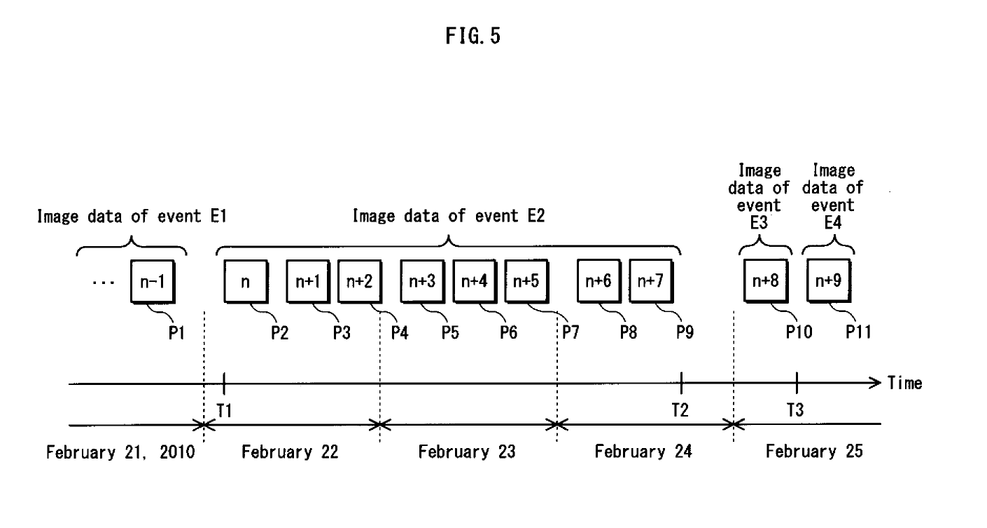

Next, an operation of the digital camera 100 will be described based on a concrete example shown in FIGS. 5 through 8.

FIG. 5 illustrates an example of timings at which a plurality of pieces of image data are generated and timings at which the state of the digital camera 100 changes.

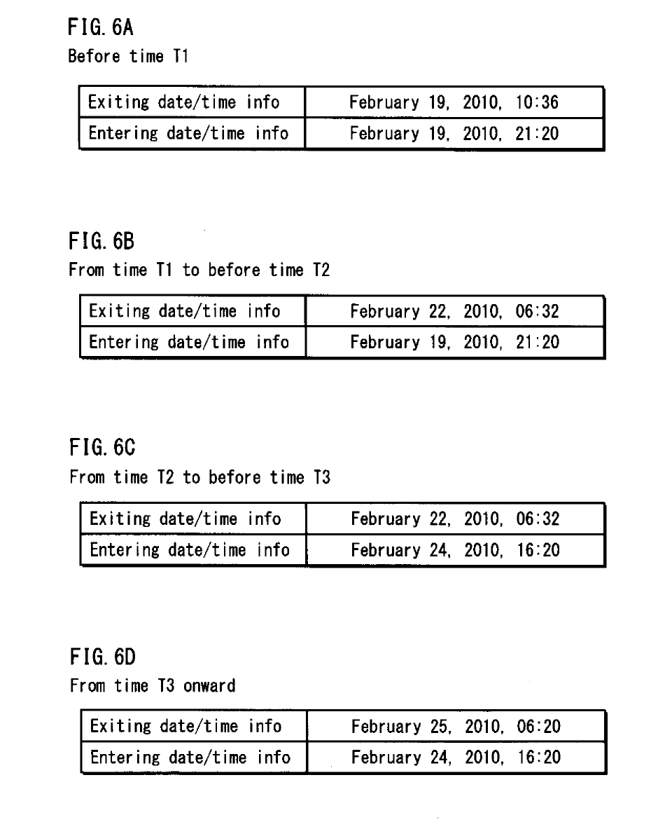

Also, FIGS. 6A through 6D illustrate how the exiting date/time information and the entering date/time information are updated.

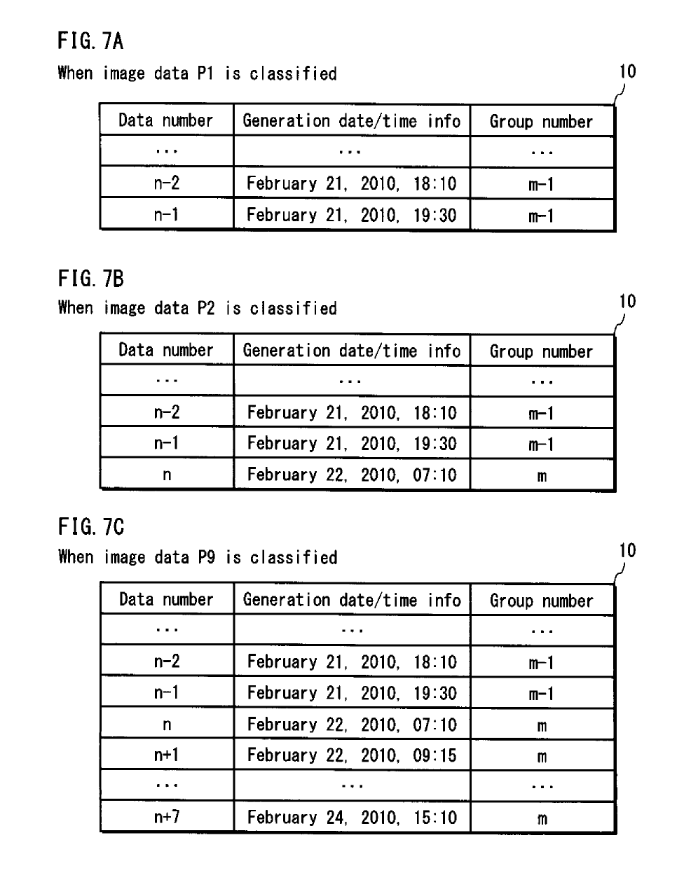

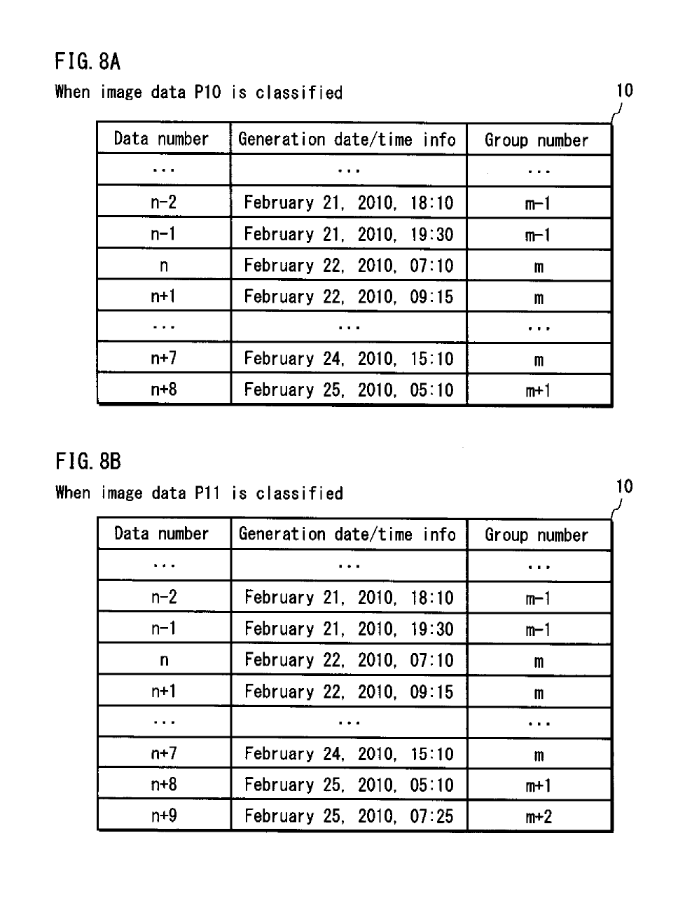

FIGS. 7A through 7C and FIGS. 8A through 8B illustrate how the image information table 10 is updated.

In FIG. 5, time T1 represents the timing at which the user with the digital camera 100 exits the home, time T2 represents the timing at which the user, who has exited the home since time T1, enters the home with the digital camera 100, and time T3 represents the timing at which the user, who has entered the home since time T2, exits the home again with the digital camera 100.

Image data P1-P11 indicate image data generated when images were captured by the digital camera 100. More specifically, FIG. 5 indicates that image data P1 was generated when an image was captured in an event E1 on February 21, 2010 in which the user with the digital camera 100 participated, image data P2-P9 were generated when images were captured in an event E2 during Feb. 22 through 24, 2010, image data P10 was generated when an image was captured in an event E3 on Feb. 25, 2010, and image data P11 was generated when an image was captured in an event E4, an event different from E3, on Feb. 25, 2010.

Also, “n−1” through “n+9”, recited in rectangular boxes in association with image data P1 through P11, represent data numbers (“n” being an integer).

The following describes an operation of the digital camera 100 with reference to the flowcharts shown in FIGS. 3 and 4, by using the concrete example illustrated in FIG. 5. It is presumed that, at the time of the start of the description, information indicating “Feb. 21, 2010, 18:10” has been registered in the image information table 10 as the generation date/time information of image data (its data number is presumed to be “n−2”) that had been generated before image data P1, and that the exiting date/time information and entering date/time information shown in FIG. 6A have been stored in the storage unit 111.

### <Classification Process for Image Data P1>

Image data (P1) generated by the image capturing unit 114 and generation date/time information (in this example, the information is indicating “Feb. 21, 2010, 19:30”) are stored by the image capturing control unit 115 into the storage unit 111 in association with each other (step S11 in FIG. 4).

After the process of step S11 is completed, the classification processing unit 120 reads generation date/time information of the previously generated image data (in this example, the information is indicating “Feb. 21, 2010, 18:10”) from the image information table 10 (step S12), and reads exiting date/time information (in this example, the information is indicating “Feb. 19, 2010, 10:36” as shown in FIG. 6A) from the storage unit 111 (step S13).

Since the generation date/time (Feb. 21, 2010, 18:10) indicated by the generation date/time information read in step S12 is later than the exiting date/time (Feb. 19, 2010, 10:36) indicated by the exiting date/time information read in step S13 (step S14: YES), the classification processing unit 120 reads entering date/time information (in this example, the information is indicating “Feb. 19, 2010, 21:20”) from the storage unit 111 (step S15).

Since the generation date/time (Feb. 21, 2010, 18:10) indicated by the generation date/time information read in step S12 is later than the entering date/time (Feb. 19, 2010, 21:20) indicated by the entering date/time information read in step S15 (step S16: YES), the classification processing unit 120 classifies the image data (P1) into the same group as the previously generated image data (step S17), and ends the classification process.

As a result of this, as shown in FIG. 7A, “m−1”, which is the same group number as the group number of the image data with data number “n−2” generated before the image data P1, is registered in the image information table 10 as a group number of the image data P1 with data number “n−1”.

### <Update Process at Time T1>

In this example, the user with the digital camera 100 exits the home at time T1. Accordingly, the detection unit 117 detects the second state where the digital camera 100 is not within the home, based on the position information stored in the position storage unit 112 and the result of calculation performed by the position calculating unit 116.

Note that, at a time before the time T1, the detection unit 117 detected the first state where the digital camera 100 is within the home.

Upon receiving a detection result from the detection unit 117 (step S1 in FIG. 3), the time information update unit 119 obtains a current date and time (in this example, the current date and time is “Feb. 22, 2010, 06:32”) from the time measuring unit 103.

Since the received detection result indicates the second state (step S2: NO), and the detection result previously received from the detection unit 117 indicates the first state where the digital camera 100 is within the home (step S3: YES), the time information update unit 119 updates the exiting date/time information stored in the storage unit 111 to indicate the date and time (Feb. 22, 2010, 06:32) obtained from the time measuring unit 103 (step S4), and ends the update process.

As a result of this, the exiting date/time information is updated from “Feb. 19, 2010, 10:36” shown in FIG. 6A to “Feb. 22, 2010, 06:32” shown in FIG. 6B.

### <Classification Process for Image Data P2>

Image data (P2) generated by the image capturing unit 114 and generation date/time information (in this example, the information is indicating “Feb. 22, 2010, 07:10”) are stored by the image capturing control unit 115 into the storage unit 111 in association with each other (step S11 in FIG. 4).

After the process of step S11 is completed, the classification processing unit 120 reads generation date/time information of the previously generated image data (in this example, the information is indicating “Feb. 21, 2010, 19:30”) from the image information table 10 (step S12), and reads exiting date/time information (in this example, the information is indicating “Feb. 22, 2010, 06:32” as shown in FIG. 6B) from the storage unit 111 (step S13).

Since the generation date/time (Feb. 21, 2010, 19:30) indicated by the generation date/time information read in step S12 is earlier than the exiting date/time (Feb. 22, 2010, 06:32) indicated by the exiting date/time information read in step S13 (step S14: NO), the classification processing unit 120 classifies the image data (P2) into a new group (step S 18), and ends the classification process.

As a result of this, as shown in FIG. 7B, “m”, which is a result of adding “1” to “m−1” which is the group number of the image data P1 generated before the image data P2, is registered in the image information table 10 as a group number of the image data P2 with data number “n”.

This indicates that the image data P1 and the image data P2 were classified as image data of respective two images that were captured in different event periods, because the digital camera 100 exited the home in a period between generation of the image data P1 and generation of the image data P2.

### <Classification Process for Image Data P3-P9>

Image data P3-P9 are processed in the same manner as described in <Classification process for image data P1> above, and image data P3-P9 are classified into the same group as the image data P2.

As a result of this, as shown in FIG. 7C, “m”, which is the same group number as the group number of the image data P2, is registered in the image information table 10 as a group number of the image data P3-P9 with data numbers “n+1”-“n+7”.

This indicates that the image data P3-P9 were classified as image data of images that were captured in one event period of several days, because the digital camera 100 did not entered the home in a period between generation of the image data P2 and generation of the image data P9.

### <Update Process at Time T2>

In this example, the user with the digital camera 100 enters the home at time T2. Accordingly, the detection unit 117 detects the first state where the digital camera 100 is within the home, based on the position information stored in the position storage unit 112 and the result of calculation performed by the position calculating unit 116.

Upon receiving a detection result from the detection unit 117 (step S1 in FIG. 3), the time information update unit 119 obtains a current date and time (in this example, the current date and time is “Feb. 24, 2010, 16:20”) from the time measuring unit 103.

Since the received detection result indicates the first state (step S2: YES), and the detection result previously received from the detection unit 117 indicates the second state (step S5: NO), the time information update unit 119 updates the entering date/time information stored in the storage unit 111 to indicate the date and time (Feb. 24, 2010, 16:20) obtained from the time measuring unit 103 (step S6), and ends the update process.

As a result of this, the entering date/time information is updated from “Feb. 19, 2010, 21:20” shown in FIG. 6B to “Feb. 24, 2010, 16:20” shown in FIG. 6C.

### <Classification Process for Image Data P10>

Image data (P10) generated by the image capturing unit 114 and generation date/time information (in this example, the information is indicating “Feb. 25, 2010, 05:10”) are stored by the image capturing control unit 115 into the storage unit 111 in association with each other (step S11 in FIG. 4).

After the process of step S11 is completed, the classification processing unit 120 reads generation date/time information of the previously generated image data (in this example, the information is indicating “Feb. 24, 2010, 15:10”) from the image information table 10 (step S12), and reads exiting date/time information (in this example, the information is indicating “Feb. 22, 2010, 06:32” as shown in FIG. 6C) from the storage unit 111 (step S13).

Since the generation date/time (Feb. 24, 2010, 15:10) indicated by the generation date/time information read in step S12 is later than the exiting date/time (Feb. 22, 2010, 06:32) indicated by the exiting date/time information read in step S13 (step 514: YES), the classification processing unit 120 reads entering date/time information (in this example, the information is indicating “Feb. 24, 2010, 16:20” as shown in FIG. 6C) from the storage unit 111 (step S15).

Since the generation date/time (Feb. 24, 2010, 15:10) indicated by the generation date/time information read in step S12 is earlier than the entering date/time (Feb. 24, 2010, 16:20) indicated by the entering date/time information read in step S15 (step 516: NO), the classification processing unit 120 classifies the image data (P10) into a new group (step S18), and ends the classification process.

As a result of this, as shown in FIG. 8A, “m+1”, which is a result of adding “1” to “m” which is the group number of the image data P9 generated before the image data P10, is registered in the image information table 10 as a group number of the image data P10 with data number “n+8”.

This indicates that the image data P9 and the image data P10 were classified as image data of respective two images that were captured in different event periods, because the digital camera 100 entered the home in a period between generation of the image data P9 and generation of the image data P10.

### <Update Process at Time T3>

In this example, the user with the digital camera 100 exits the home again at time T3 (in this example, the time is presumed to be “Feb. 25, 2010, 06:20”). Accordingly, the update process is performed in the same manner as described in <Update process at time T1> above.

As a result of this, the exiting date/time information is updated from “Feb. 22, 2010, 06:32” shown in FIG. 6C to “Feb. 25, 2010, 06:20” shown in FIG. 6D.

### <Classification Process for Image Data P11>

Image data P11 is processed in the same manner as described in <Classification process for image data P2> above, and image data P11 is classified into a different group from the image data P10.

As a result of this, as shown in FIG. 8B, “m+2”, which is a result of adding “1” to “m+1” which is the group number of the image data P10 generated before the image data P11, is registered in the image information table 10 as a group number of the image data P11 with data number “n+9”.

This indicates that the image data P10 and the image data P11 were classified as image data of respective two images that were captured in different event periods, because the digital camera 100 exited the home again in a period between generation of the image data P10 and generation of the image data P11.

As described above, with the structure of the content generation classification device 110 in the present embodiment, it is possible to increase the probability of classifying each piece of image data into any event by classifying the image data (P1-P11) into event periods. That is to say, a plurality of pieces of image data (P2-P9) generated in an event that extends for a plurality of days like the event E2 can be classified into one group. Also, if a plurality of events occur on the same day as in the case of events E3 and E4, each piece of image data (P10, P11) generated in the plurality of events can be classified into one of the events.

### <Display Example>

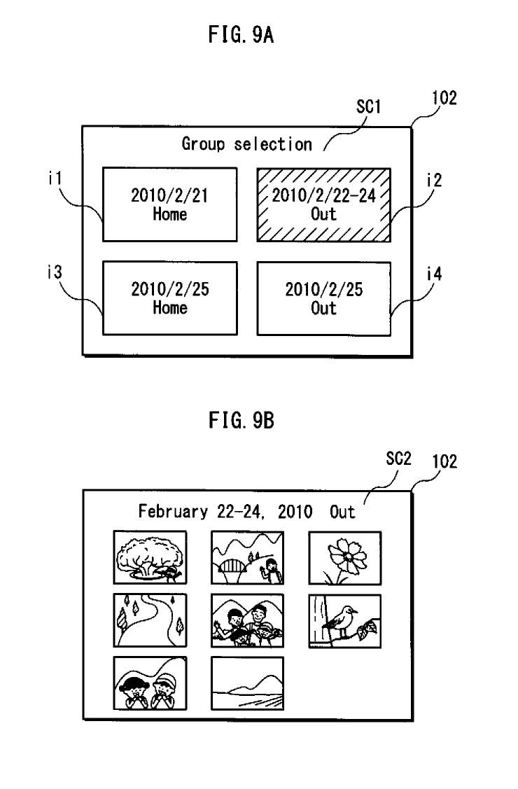

FIGS. 9A and 9B illustrate display examples of classification results.

FIG. 9A shows a group selection screen SC1 displayed on the display unit 102 by the classification unit 118 upon receiving a predetermined user operation from the operation unit (not illustrated) immediately after the image data P11 in the above-described example shown in FIG. 5 is classified.

In this example, the group selection screen SC1 includes icons i1 through i4 indicating four groups to which the image data shown in FIG. 5 belong, respectively.

Immediately after the image data P11 is classified, there are four groups with group numbers “m−1” through “m+2”, as shown in FIG. 8B. The group selection screen SC1 is an example display where icon i1 represents a group with group number “m−1”, icon i2 represents a group with group number “m”, icon i3 represents a group with group number “m+1”, and icon i4 represents a group with group number “m+2”. Note that, in this example of the group selection screen SC1, the generation date(s) and the generation place (home or outside) of the image data belonging to the group associated with the icon are displayed on each icon. This facilitates the user to identify the groups associated with event periods indicated by the icons i1 through i4.

FIG. 9B illustrates a thumbnail screen SC2 displayed on the display unit 102 by the classification unit 118 upon receiving a user operation for selecting the icon i2, from the operation unit (not illustrated).

In the above example, eight pieces of image data P2 through P9 belong to the group with group number “m”. Accordingly, in the thumbnail screen SC2, eight thumbnails (reduced images) of the image data P2 through P9 displayed are arranged starting from the upper-left corner in the order of image capturing.

Note that the present example of the thumbnail screen SC2 can display nine thumbnails at once. Thus, if there are 10 or more pieces of image data belonging to one group, a thumbnail screen including nine thumbnails of the first through ninth pieces of image data in the capturing order may be displayed first, and then a thumbnail screen including thumbnails of the 10^{th} and succeeding pieces of image data may be displayed, in accordance with the user operation.

In this way, it is possible to display thumbnails of image data for each group to which the image data belong, in association with the event periods. This facilitates the user to display desired image data.

### Embodiment 2

In Embodiment 1, generation and classification of image data are performed one digital camera 100. Embodiment 2 describes a content classification system 1000 as one embodiment of a content classification system of the present invention, in which an independent device (content classification device) classifies image data generated by a digital camera (another independent device in the system).

### <Structure>

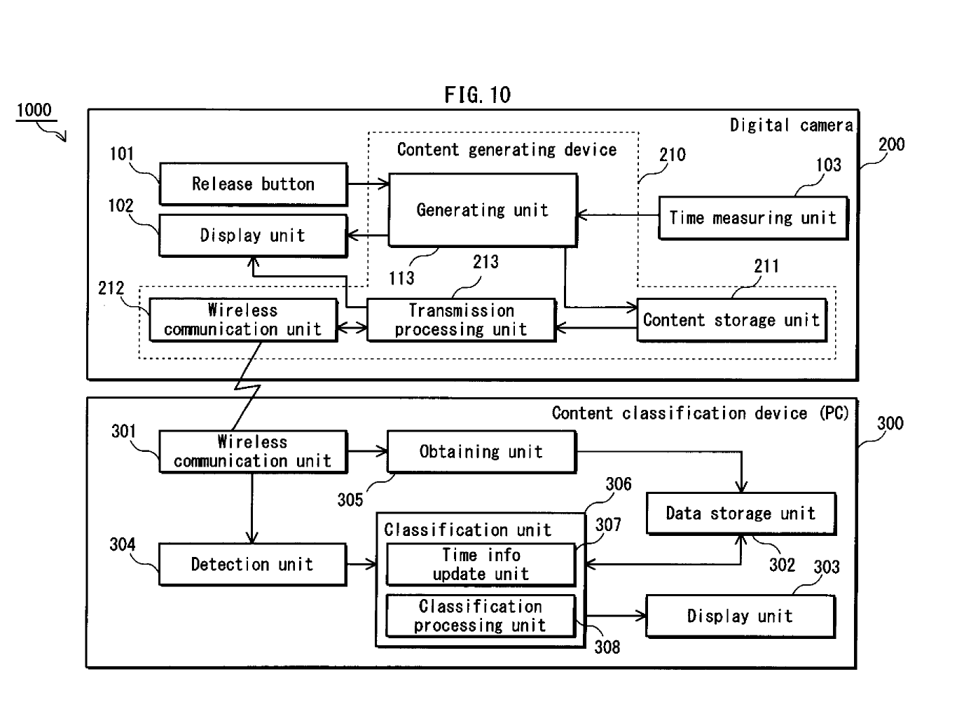

First, the structure of the content classification system 1000 in the present embodiment will be described with reference to FIG. 10.

FIG. 10 is a block diagram illustrating a system structure of the content classification system 1000 in Embodiment 2.

As shown in FIG. 10, the content classification system 1000 includes a digital camera 200 and a content classification device 300.

### <Digital Camera>

First, a structure of the digital camera 200 will be described.

As shown in FIG. 10, the digital camera 200 is provided with a content generating device 210 in place of the content generation classification device 110 in the digital camera 100 of Embodiment 1.

The content generating device 210 includes a generating unit 113, a content storage unit 211, a wireless communication unit 212, and a transmission processing unit 213, wherein the generating unit 113 is the same as the generating unit 113 provided in the content generation classification device 110 of Embodiment 1.

The content storage unit 211 is similar to the storage unit 111 in Embodiment 1 in that it is realized by a recording medium such as a memory or a hard disk and has a function to store generated image data, but is different therefrom in that it stores an image information table (hereinafter referred to as a “modified image information table”) which has been slightly modified from the image information table 10 in Embodiment 1, but does not store the exiting date/time information and the entering date/time information.

The modified image information table is the same as the image information table 10 of Embodiment 1 shown in FIG. 2 except that it lacks the group number 13. That is to say, although it is neither illustrated nor explained, the modified image information table is information indicating the data number 11 and the generation date/time information 12 in association with each other for each piece of image data. In the following, each piece of information composed of the data number 11 and the generation date/time information 12 may also be referred to as a “record”.

The wireless communication unit 212 is a circuit for performing transmission/reception of radio waves, and is realized by a wireless LAN adaptor conforming to, for example, the IEEE 802.11 standard.

The wireless communication unit 212 has a function to, each time it receives what is called beacon signal that is transmitted repeatedly from the content classification device 300, transmit a response signal in response to the received beacon signal.

Also, the wireless communication unit 212 has a function to, if it receives a beacon signal in the non-connection state, notify the transmission processing unit 213 of the reception, and transmit a connection request signal to the content classification device 300 in accordance with an instruction from the transmission processing unit 213, the connection request signal containing an SSID (Service Set IDentifier) having originally been set in the content classification device 300. Furthermore, the wireless communication unit 212 has a function to receive, from the content classification device 300 having received this connection request signal, a connection permission signal, establish a connection with the content classification device 300, and transmit image data or the like to the content classification device 300 in accordance with an instruction from the transmission processing unit 213.

Note that the SSID to be contained in the connection request signal may be obtained from the beacon signal that is repeatedly transmitted from the content classification device 300, as in a conventional method, or may be stored in the digital camera 200 in advance.

The transmission processing unit 213 has a function to manage whether or not each piece of image data stored in the content storage unit 211 has been transmitted to the content classification device 300, extract records of untransmitted pieces of image data from the modified image information table, and transmit extracted records, the untransmitted pieces of image data and data numbers thereof to the content classification device 300 via the wireless communication unit 212.

The transmission processing unit 213 performs the transmission in accordance with an instruction from the user. That is to say, upon receiving a notification of a reception of a beacon signal from the wireless communication unit 212, the transmission processing unit 213 displays a message on the display unit 102 to urge the user to determine whether or not to transmit untransmitted image data stored in the content storage unit 211 to the content classification device 300. If it receives, as a response to the message, a user operation instructing to transmit the untransmitted image data, the transmission processing unit 213 instructs the wireless communication unit 212 to transmit a connection request signal, and after the connection with the content classification device 300 is established, transmits the image data and the like to the content classification device 300.

### <Content Classification Device>

Next, a structure of the content classification device 300 will be described.

The content classification device 300 is realized by a personal computer (PC) including a display, and as shown in FIG. 10, includes a wireless communication unit 301, a data storage unit 302, a display unit 303, a detection unit 304, an obtaining unit 305, and a classification unit 306.

The wireless communication unit 301 is a circuit for performing transmission/reception of radio waves, and operates as what is called access point conforming to, for example, the IEEE 802.11 standard.

The wireless communication unit 301 has a function to, if it receives a response signal in response to what is called a beacon signal that is repeatedly transmitted, notify the detection unit 304 of the reception of the response signal.

Also, the wireless communication unit 301 has a function to, if it receives a connection request signal containing the SSID of the content classification device 300, transmit a connection permission signal, receive image data and the like from the digital camera 200, and send the received data to the obtaining unit 305.

The data storage unit 302 is realized by a recording medium such as a memory or a hard disk, and has a function to store the image data received from the digital camera 200 via the wireless communication unit 301, and the image information table 10 described above in Embodiment 1 (see FIG. 2).

The display unit 303 is, for example, a Liquid Crystal Display (LCD), and has a function to display, in accordance with an instruction from the classification unit 306, a thumbnail screen similar to a thumbnail screen described in Embodiment 1 (see FIG. 9).

The detection unit 304 has a function to repeatedly detect whether the digital camera 200 is within the home (first state) or not (second state), based on whether or not a notification of a reception of a response signal has been received from the wireless communication unit 301.

The detection unit 304 detects the first state when a response signal has been received, and detects the second state when a response signal has not been received, and transmits the detection result to the classification unit 306.

The obtaining unit 305 has a function to store image data received from the wireless communication unit 301 and data numbers into the data storage unit 302 in association with each other, and register records, which are received together with the image data, in the image information table 10 stored in the data storage unit 302.

The classification unit 306 has a function similar to the function of the classification unit 118, namely, a function to classify image data stored in the data storage unit 302 into event periods, based on the result of the detection received from the detection unit 117. The classification unit 306 includes a time information update unit 307 and a classification processing unit 308.

As is the case with the classification unit 118, the classification unit 306 also has a function to display thumbnails of image data on the display unit 303 based on the classification result, upon receiving a predetermined user operation from an operation unit (not illustrated).

Basically, the time information update unit 307 has the same function as the time information update unit 119, but is different therefrom in that it manages exiting and entering dates and times that are later than the time when the classification processing unit 308 completed a classification of image data having been stored previously by the obtaining unit 305 in the data storage unit 302. That is to say, while the time information update unit 119 of Embodiment 1 manages exiting and entering dates and times of one generation, the time information update unit 307 of the present embodiment may manage exiting and entering dates and times of a plurality of generations.

Basically, the classification processing unit 308 has the same function as the classification processing unit 120, but is different therefrom in that it classifies image data in an order of generation after the obtaining unit 305 completes storing image data received from the digital camera 200 into the data storage unit 302.

### <Data>

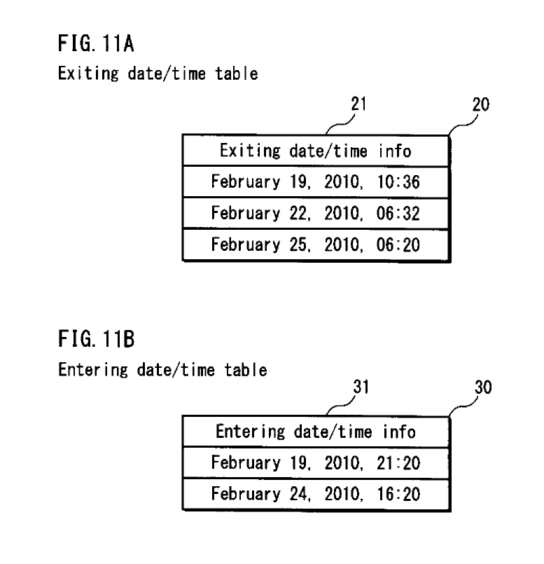

Next, data used by the content classification device 300 will be described with reference to FIGS. 11A and 11B.

FIG. 11A illustrates an example of the data structure and contents of an exiting date/time table 20.

As shown in FIG. 11A, the exiting date/time table 20 is information composed of exiting date/time information 21 in which times, at which exiting of the user with the digital camera 200 was detected after the classification processing unit 308 completed a previous classification of image data, are registered in the order of detection.

FIG. 11A indicates, for example, that exiting the user's home of the digital camera 200 was detected at “Feb. 19, 2010, 10:36”, “Feb. 22, 2010, 06:32”, and “Feb. 25, 2010, 06:20” after the completion of the previous classification.

FIG. 11B illustrates an example of the data structure and contents of an entering date/time table 30.

As shown in FIG. 11B, the entering date/time table 30 is information composed of entering date/time information 31 in which times, at which entering of the user with the digital camera 200 was detected after the classification processing unit 308 completed a previous classification of image data, are registered in the order of detection.

FIG. 11B indicates, for example, that entering the user's home of the digital camera 200 was detected at “Feb. 19, 2010, 21:20” and “Feb. 24, 2010, 16:20” after the completion of the previous classification.

### <Operation>

Next, an operation of the content classification device 300 will be described.

### <Update Process>

The update process performed by the time information update unit 307 to update the exiting date/time table 20 and the entering date/time table 30 is almost the same as the update process performed by the time information update unit 119 to update the exiting and entering date/time information in Embodiment 1 (see FIG. 3), with a slight changed added to the processes of steps S4 and S6.

More specifically, although not illustrated specifically, the update process of the present embodiment is performed as follows: in step S4, a piece of exiting date/time information indicating a date and time obtained from the time measuring unit is added into the exiting date/time table 20; and in step S6, a piece of entering date/time information indicating a date and time obtained from the time measuring unit is added into the entering date/time table 30.

### <Classification Process>

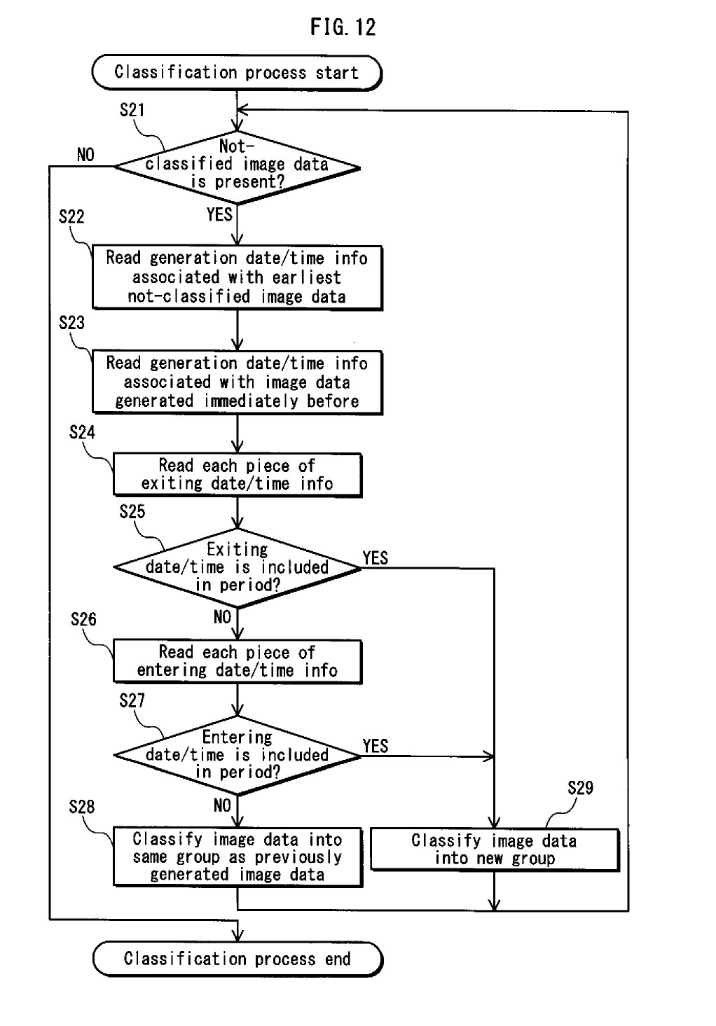

FIG. 12 is a flowchart showing a classification process performed by the classification processing unit 308.

After image data received from the digital camera 200 and data numbers are stored in association with each other into the data storage unit 302 by the obtaining unit 305, and records are registered in the image information table 10, the classification processing unit 308 judges whether or not not-classified image data is present (step S21).

If the image information table 10 has a record for which a group number has not been registered, the classification processing unit 308 judges that not-classified image data is present (step S21: YES); and if the image information table 10 does not have a record for which a group number has not been registered, the classification processing unit 308 judges that not-classified image data is not present (step S21: NO).

If not-classified image data is present (step S21: YES), the classification processing unit 308 reads, from the image information table 10, a piece of generation date/time information associated with a piece of image data having the earliest generation date/time (hereinafter the image data may be referred to as “target image data”) among the not-classified image data (step S22), and reads, from the image information table 10, a piece of generation date/time information associated with a piece of image data that was generated immediately before the target image data (step S23).

Also, the classification processing unit 308 reads each piece of exiting date/time information from the exiting date/time table 20 (step S24).

The classification processing unit 308 then judges whether or not an exiting date/time indicated by a piece of exiting date/time information read in step S24 is included in a period between (i) a generation date/time indicated by the generation date/time information, read in step S23, associated with the image data generated immediately before the target image data, and (ii) a generation date/time indicated by the generation date/time information, read in step S22, associated with the target image data (step S25).

If it judges that the period does not include any of the exiting dates/times (step S25: NO), the classification processing unit 308 reads each piece of entering date/time information from the entering date/time table 30 (step S26).

Following this, the classification processing unit 308 then judges whether or not an entering date/time indicated by a piece of entering date/time information read in step S26 is included in a period between (i) the generation date/time indicated by the generation date/time information, read in step S23, associated with the image data generated immediately before the target image data, and (ii) the generation date/time indicated by the generation date/time information, read in step S22, associated with the target image data (step S27).

If it judges that the period does not include any of the entering dates/times (step S27: NO), the classification processing unit 308 classifies the target image data into the same group as the image data that was generated immediately before the target image data, as in step S17 shown in FIG. 4 (step S28), and returns to step S21.

If it judges that the period includes any of the exiting dates/times (step S25: YES), or judges that the period includes any of the entering dates/times (step S27: YES), the classification processing unit 308 classifies the target image data into a new group, as in step S18 of FIG. 4 (step S29), and returns to step S21.

If it judges that not-classified image data is not present (step S21: NO), the classification processing unit 308 ends the classification process.

Note that when the classification processing unit 308 ends the classification process, the time information update unit 307 deletes all the exiting date/time information from the exiting date/time table 20, and deletes all the entering date/time information from the entering date/time table 30.

<Explanation of Operation with Concrete Example>

The following describes a classification process performed by the content classification device 300 with reference to the flowchart shown in FIG. 12, by using the concrete examples illustrated in FIGS. 5, 7, 8 and 11.

In the present example, it is presumed that the content classification device 300 received, from the digital camera 200, image data P1 through P11 generated at the timings illustrated in FIG. 5 and records registered in the modified image information table in association with the image data P1 through P11, the image data P1 through P11 have been stored in the data storage unit 302, and the records have been registered in the image information table 10.

### <Classification Process for Image Data P1>

In this example, since not-classified image data P1 through P11 are present (step S21 of FIG. 12: YES), the classification processing unit 308 reads, from the image information table 10, a piece of generation date/time information associated with image data P1 that has the earliest generation date/time (in this example, “Feb. 21, 2010, 19:30”) among the not-classified image data (step S22), and reads, from the image information table 10, a piece of generation date/time information (in this example, the information is presumed to indicate “Feb. 21, 2010, 18:10”) associated with a piece of image data that was generated immediately before the image data P1 (step S23).

Also, the classification processing unit 308 reads each piece of exiting date/time information (as shown in FIG. 11A, exiting date/time information indicating “Feb. 19, 2010, 10:36”, “Feb. 22, 2010, 06:32”, and “Feb. 25, 2010, 06:20”) from the exiting date/time table 20 (step S24).

Since any of the exiting dates/times is not included in a period between (i) a generation date/time (“Feb. 21, 2010, 18:10”) indicated by the generation date/time information read in step S23 and (ii) a generation date/time (“Feb. 21, 2010, 19:30”) indicated by the generation date/time information read in step S22 (step S25: NO), the classification processing unit 308 reads each piece of entering date/time information (as shown in FIG. 11B, entering date/time information indicating “Feb. 19, 2010, 21:20” and “Feb. 24, 2010, 16:20”) from the entering date/time table 30 (step S26).

Since any of the entering dates/times is not included in a period between (i) the generation date/time (“Feb. 21, 2010, 18:10”) indicated by the generation date/time information read in step S23 and (ii) the generation date/time (“Feb. 21, 2010, 19:30”) indicated by the generation date/time information read in step S22 (step S27: NO), the classification processing unit 308 classifies the image data P1 into the same group as the image data that was generated immediately before the image data P1 (step S28).

As is the case with Embodiment 1, as a result of this, as shown in FIG. 7A, “m−1”, which is the same group number as the group number of the image data with data number “n−2” generated immediately before the image data P1, is registered in the image information table 10 as a group number of the image data P1 with data number “n−1”.

### <Classification Process for Image Data P2>

In this example, since not-classified image data P2 through P11 are present (step S21: YES), the classification processing unit 308 reads, from the image information table 10, a piece of generation date/time information associated with image data P2 that has the earliest generation date/time (in this example, “Feb. 22, 2010, 07:10”) among the not-classified image data (step S22), and reads, from the image information table 10, a piece of generation date/time information (in this example, indicating “Feb. 21, 2010, 19:30”) associated with a piece of image data that was generated immediately before the image data P2 (step S23).

Also, the classification processing unit 308 reads each piece of exiting date/time information (indicating “Feb. 19, 2010, 10:36”, “Feb. 22, 2010, 06:32”, and “Feb. 25, 2010, 06:20”) from the exiting date/time table 20 (step S24).

Since an exiting date/time (“Feb. 22, 2010, 06:32”) is included in a period between (i) the generation date/time (“Feb. 21, 2010, 19:30”) indicated by the generation date/time information read in step S23 and (ii) the generation date/time (“Feb. 22, 2010, 07:10”) indicated by the generation date/time information read in step S22 (step S25: YES), the classification processing unit 308 classifies the image data P2 into a new group (step S29).

As is the case with Embodiment 1, as a result of this, as shown in FIG. 7B, “m”, which is a result of adding “1” to “m−1” which is the group number of the image data P1 generated immediately before the image data P2, is registered in the image information table 10 as a group number of the image data P2 with data number “n”.

### <Classification Process for Image Data P3-P9>

Image data P3-P9 are processed in the same manner as described in <Classification process for image data P1> above, and image data P3-P9 are classified into the same group as the image data P2.

As is the case with Embodiment 1, as a result of this, as shown in FIG. 7C, “m”, which is the same group number as the group number of the image data P2, is registered in the image information table 10 as a group number of the image data P3-P9 with data numbers “n+1”-“n+7”.

### <Classification Process for Image Data P10>

In this example, since not-classified image data P10 and P11 are present (step S21 of FIG. 12: YES), the classification processing unit 308 reads, from the image information table 10, a piece of generation date/time information associated with image data P10 that has the earliest generation date/time (in this example, “Feb. 25, 2010, 05:10”) among the not-classified image data (step S22), and reads, from the image information table 10, a piece of generation date/time information (in this example, indicating “Feb. 24, 2010, 15:10”) associated with a piece of image data that was generated immediately before the image data P10 (step S23).

Also, the classification processing unit 308 reads each piece of exiting date/time information (as shown in FIG. 11A, exiting date/time information indicating “Feb. 19, 2010, 10:36”, “Feb. 22, 2010, 06:32”, and “Feb. 25, 2010, 06:20”) from the exiting date/time table 20 (step S24).

Since any of the exiting dates/times is not included in a period between (i) a generation date/time (“Feb. 24, 2010, 15:10”) indicated by the generation date/time information read in step S23 and (ii) a generation date/time (“Feb. 25, 2010, 05:10”) indicated by the generation date/time information read in step S22 (step 525: NO), the classification processing unit 308 reads each piece of entering date/time information (as shown in FIG. 11B, entering date/time information indicating “Feb. 19, 2010, 21:20” and “Feb. 24, 2010, 16:20”) from the entering date/time table 30 (step S26).

Since an entering date/time (“Feb. 24, 2010, 16:20”) is included in a period between (i) the generation date/time (“Feb. 24, 2010, 15:10”) indicated by the generation date/time information read in step S23 and (ii) the generation date/time (“Feb. 25, 2010, 05:10”) indicated by the generation date/time information read in step S22 (step S27: YES), the classification processing unit 308 classifies the image data P10 into a new group (step S29).

As is the case with Embodiment 1, as a result of this, as shown in FIG. 8A, “m+1”, which is a result of adding “1” to “m” which is the group number of the image data P9 generated before the image data P10, is registered in the image information table 10 as a group number of the image data P10 with data number “n+8”.

### <Classification Process for Image Data P11>

Image data P11 is processed in the same manner as described in <Classification process for image data P2> above, and image data P11 is classified into a different group from the image data P10.

As is the case with Embodiment 1, as a result of this, as shown in FIG. 8B, “m+2”, which is a result of adding “1” to “m+1” which is the group number of the image data P10 generated before the image data P11, is registered in the image information table 10 as a group number of the image data P11 with data number “n+9”.

### Modification 1

As described above, in the content classification system 1000 of Embodiment 2, the content classification device 300 detects whether the digital camera 200 is within the home (first state) or not (second state), based on whether or not a response signal has been received from the digital camera 200.

In the following, the present modification, in which the digital camera is provided with an IC (Integrated Circuit) tag, and the content classification device detects the state of the digital camera (the first state or the second state) based on whether or not a signal has been received from the IC tag, will be described centering on the differences from Embodiment 2.

### <Structure>

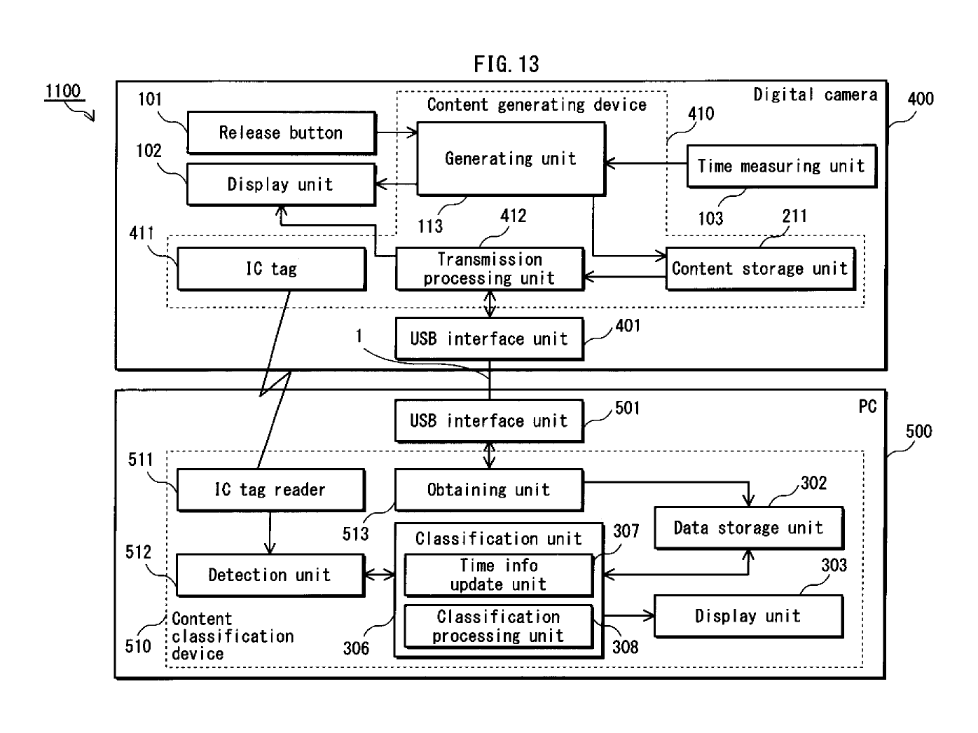

The structure of the content classification system 1100 in Modification 1 will be described with reference to FIG. 13.

FIG. 13 is a block diagram illustrating a system structure of the content classification system 1100 in Modification 1.

As shown in FIG. 13, the content classification system 1100 includes a digital camera 400 and a personal computer (PC) 500, the PC 500 including a content classification device 510. The digital camera 400 and the PC 500 can be connected with each other by a USB (Universal Serial Bus) cable 1. The USB cable 1 is, for example, in compliance with the USB 2.0 standard, and is, for example, 50 cm long.

First, a structure of the digital camera 400 will be described.

As shown in FIG. 13, the digital camera 400 is different from the digital camera 200 in Embodiment 2 in that is includes a content generating device 410 instead of the content generating device 210, and additionally includes a USB interface unit 401.

The USB interface unit 401 has a function to, upon detecting a connection with the PC 500 via a USB interface unit 501 which will be described later, notify the content generating device 410 of the detection, and transmit image data or the like to the PC 500 in accordance with an instruction from the content generating device 410.

Also, the content generating device 410 is different from the content generating device 210 in Embodiment 2 in that it includes an IC tag 411 and a transmission processing unit 412 instead of the wireless communication unit 212 and the transmission processing unit 213.

The IC tag 411 includes an LF (Low Frequency) antenna and a UHF (Ultra High Frequency) antenna, the LF antenna being used to receive signals in the LF band, and the UHF antenna being used to transmit signals in the UHF band. The IC tag 411 has a function to transmit a UHF-band signal containing identification information of the digital camera 400 each time it receives an LF-band signal.

The transmission processing unit 412 basically has the same function as the transmission processing unit 213 in Embodiment 2 except that, upon receiving a notification of a detection of a connection with the PC 500 from the USB interface unit 401, it transmits (i) image data not having been transmitted to the PC 500 and the data numbers thereof and (ii) records extracted from the modified image information table in association with the untransmitted image data, to the PC 500 via the USB interface unit 401.

If it receives a notification of a detection of a connection with the PC 500 from the USB interface unit 401, the transmission processing unit 412 displays onto the display unit 102 a message asking the user whether untransmitted image data stored in the content storage unit 211 should be transmitted to the PC 500, and transmits the image data and the like if it receives a user operation instructing to transmit the image data, from an operation unit (not illustrated).

Next, a structure of the PC 500 will be described.

As shown in FIG. 13, the PC 500 includes a USB interface unit 501 and a content classification device 510.

The USB interface unit 501 has a function to detect a connection with the digital camera 400, via the USB interface unit 401, receive image data or the like from the digital camera 400, and send the received data to an obtaining unit 513.

The content classification device 510 is different from the content classification device 300 in Embodiment 2 in that is includes an IC tag reader 511, a detection unit 512, and the obtaining unit 513 instead of the wireless communication unit 301, detection unit 304, and obtaining unit 305.

The IC tag reader 511 includes an LF antenna for transmitting an LF-band signal, and has a function to transmit the LF-band signal repeatedly. Note that an area in which the digital camera 400 can receive an LF-band signal is relatively narrow, and in the present modification, it is presumed that the digital camera 400 can receive an LF-band signal when it becomes as close as approximately 1.5 m to the content classification device 510, without any object therebetween.

The IC tag reader 511 includes a UHF antenna for receiving a UHF-band signal, and has a function to, if it receives a UHF-band signal containing identification information that is identical with identification information of the digital camera 400 stored therein in advance, notify the detection unit 512 of the reception.

The detection unit 512 basically has the same function as the detection unit 304 in Embodiment 2, except that it detects which of the first state and the second state the digital camera 400 is in, based on whether or not it received, from the IC tag reader 511, the notification that a UHF-band signal containing identification information that is identical with identification information of the digital camera 400 stored therein in advance had been received.

The obtaining unit 513 basically has the same function as the obtaining unit 305 in Embodiment 2, except that it receives, from the USB interface unit 501, image data and the like transmitted from the digital camera 400.

### <Operation>

The update process for updating the exiting date/time table 20 and the entering date/time table 30 and the classification process performed by the classification unit 306 of the content classification device 510 in the present modification are the same as those explained in Embodiment 2, and thus description thereof is omitted.

### Modification 2

In the content classification system 1100 of Modification 1, the PC 500 detects whether the digital camera 400 is within the home (first state) or not (second state), based on whether or not it received a UHF-band signal containing identification information of the digital camera 400.

The following describes a modification in which a PC including a content classification device detects the state of a digital camera, based on whether or not a connection with the digital camera via a USB cable was detected, centering on differences from Modification 1.

### <Structure>

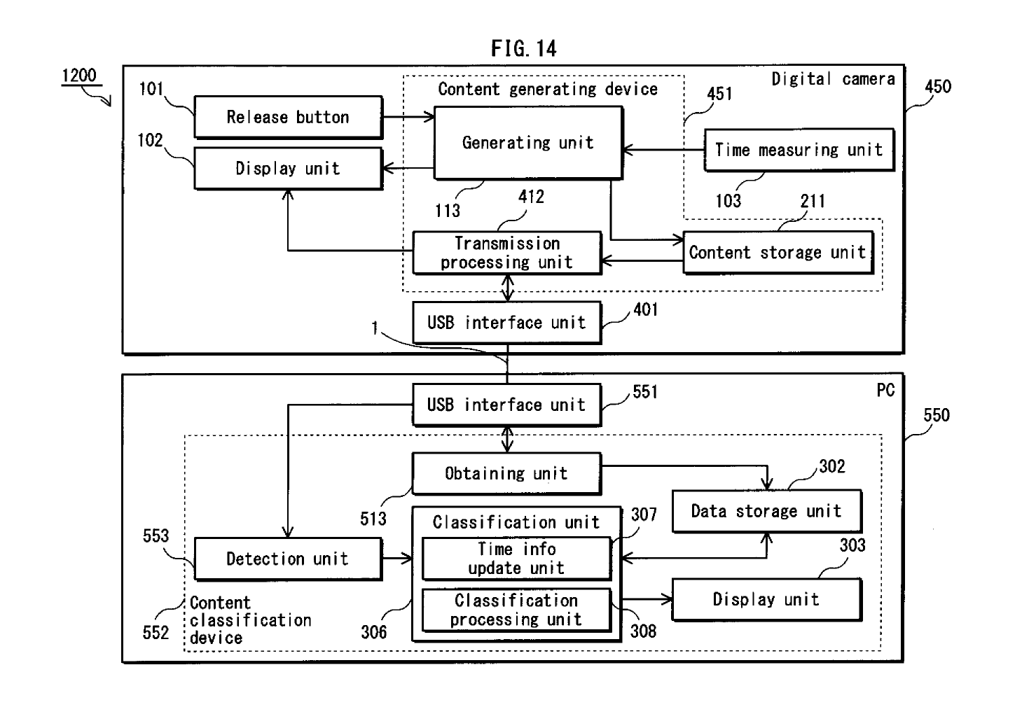

The structure of a content classification system 1200 in Modification 2 will be described with reference to FIG. 14.

FIG. 14 is a block diagram illustrating a system structure of the content classification system 1200 in Modification 2.

As shown in FIG. 14, the content classification system 1200 includes a digital camera 450 and a PC 550, the PC 550 including a content classification device 552. As in Modification 1, the digital camera 450 and the PC 550 can be connected with each other by the USB cable 1.

As shown in FIG. 14, the digital camera 450 has the same structural elements as the digital camera 400 in Modification 1 except that it includes a content generating device 451 instead of the content generating device 410, and the content generating device 451 has the same structural elements as the content generating device 410 except that it does not include the IC tag 411.

Also, the PC 550 has the same structural elements as the PC 500 in Modification 1 except that it includes a USB interface unit 551 and the content classification device 552 instead of the USB interface unit 501 and the content classification device 510.

The USB interface unit 551 has the same function as the USB interface unit 501 in Modification 1, and further has a function to, if it detects a connection with or disconnection from the digital camera 450 via the USB interface unit 401, notify a detection unit 553 of the connection/disconnection.

The content classification device 552 has the same structural elements as the content classification device 510 in Modification 1 except that it includes the detection unit 553 instead of the detection unit 512, and it does not include the IC tag reader 511.

The detection unit 553 basically has the same function as the detection unit 512 in Modification 1 except that it detects which of the first state and the second state the digital camera 450 is in, based on a notification from the USB interface unit 551 that a connection with or disconnection from the digital camera 450 was detected.

That is to say, the detection unit 553 continues to detect the first state during a period after a reception of a notification that a connection was detected until a reception of a notification that a disconnection was detected; and continues to detect the second state during a period after a reception of a notification that a disconnection was detected until a reception of a notification that a connection was detected.

### <Operation>

The update process for updating the exiting date/time table 20 and the entering date/time table 30 and the classification process performed by the classification unit 306 of the content classification device 552 in the present modification are the same as those explained in Embodiment 2, and thus description thereof is omitted.

### Supplementary Notes

Up to now, the content classification system, content generation classification device, and content classification device of the present invention have been described based on embodiments and modifications (hereinafter they may be referred merely as “Embodiments”). However, the present invention is not limited the content classification system, content generation classification device, and content classification device described above in the Embodiments, but may be modified, for example, as follows.

(1) In the Embodiments, image data of images captured by a digital camera are described as example of contents that are to be classified. However, the target of classification is not limited to such image data, but may be various types of data generated by various types of machines that can be carried by the user. Examples of the various types of machines include, for example, mobile terminals such as a mobile telephone, notebook personal computer, and PDA (Personal Digital Assistant), and a video camera. Also, examples of the various types of data include, for example, video data, audio data, and lifelog.

(2) In the above description of Modification 1, the IC tag 411 transmits a UHF-band signal if it receives an LF-band signal. However, not limited to this, the IC tag may transmit an LF-band signal or UHF-band signal even if it does not receive an LF-band signal. In that case, the IC tag reader 511 in Modification 1 does not need to transmit the LF-band signal, but only needs to receive a signal from the IC tag in this modification.

(3) In the above description of Embodiment 2, the content classification device 300 detects the state (first state or second state) of the digital camera 200, and classifies image data.

However, the structure may be modified such that the digital camera 200 detects the state of the camera itself based on whether or not it received a beacon signal transmitted from the content classification device 300, and classifies image data based on the detection result. In the following description in this section, the digital camera modified in this manner is referred to as “Modified digital camera”.

Also, in connection with this modification, the content classification device 300 may be modified so that it functions as a content management device for storing, into the data storage unit 302, image data obtained from the Modified digital camera via the wireless communication unit 301.

The content management device may be realized by a personal computer, or a device having a function to store data (for example, a computer such as a server, or NAS (Network Attached Storage)) and further having a wireless communication function. When, in particular, contents to be classified are video data, the content management device may be realized by an HDD (Hard Disk Drive) recorder further having a wireless communication function.

Also, in the above modification, the content management device obtains image data from the Modified digital camera via the wireless communication unit 301. However, not limited to this, as explained in Modification 1, the content management device may obtain image data via a USB.

(4) Embodiment 1 has not described a content management device for obtaining image data from the digital camera 100 and storing the obtained image data. However, the digital camera 100 may be modified to be able to connect, wirelessly or by a wired connection, to such a content management device, and the modified digital camera and the content management device that can be connected to the modified digital camera wirelessly or by a wired connection may constitute a content classification system.

(5) In Embodiment 1, “Home” or “Out” is included in each icon displayed on the group selection screen SC1 (see FIG. 9A), to indicate a location at which the image data belonging to the group represented by the icon were generated. However, not limited to this, when the digital camera 100 captures an image, it may store an image capturing position (latitude, longitude) which is determined based on a signal received from a GPS satellite, and then may display specific information of the location (for example, a prefecture name, city name, or region name).

(6) In the Embodiments, the exiting date/time information and the entering date/time information are stored with a distinction between them. However, not limited to this, merely information indicating dates/times on which the state of the digital camera changed may be stored in correspondence with a plurality of generations, with no particular distinction between the exiting date/time information and the entering date/time information.

In that case, note that, since the judgment on whether the digital camera was exiting or entering the home cannot be made, it is impossible for each icon displayed on the group selection screen SC1 (see FIG. 9A) to indicate a location (“home” or “out”) at which the image data belonging to the group represented by the icon were generated.

(7) In Modifications 1 and 2, a USB cable is used as one example of means for connecting a digital camera with a PC. However, not limited to this, a cable, for example an RS-232C cable, other than the USB cable may be used as the connection means.

(8) In Embodiment 2 and the modifications, there is only one digital camera that includes the content generating device. However, not limited to this, there may be a plurality of digital cameras including the content generating device. In that case, the content generating device in each digital camera may transmit identification information of the content generating device itself, together with each piece of image data, and the classification processing unit of the content classification device in Embodiment 2 and the modifications may classify image data for each of content generating devices in digital cameras, based on the received identification information.

(9) Modification 1 describes an example in which the PC 500 obtains, via the USB cable 1, image data generated by the digital camera 400. However, not limited to this, for example, the content storage unit 211 may be realized by a memory card (nonvolatile memory) which is detachable from the digital camera 400, and the PC 500 may be connected with a memory card reading device and may obtain, by using the memory card reading device, image data from the memory card detached from the digital camera 400. Note that this modification does not require the USB interface unit (401, 501).

(10) In the above description of Embodiment 2, the transmission processing unit 213 included in the content generating device 210 of the digital camera 200 instructs the wireless communication unit 212 to transmit a connection request signal if it receives a user operation instructing so. However, not limited to this, the transmission processing unit may automatically instruct the wireless communication unit 212 to transmit a connection request signal if the transmission processing unit receives a notification from the wireless communication unit 212 of a reception of a beacon signal, without waiting for a reception of a user instruction, and transmit image data or the like after a connection with the content classification device 300 is established.

Similarly, the transmission processing unit 412 of the content generating device included in the digital camera of each modification may transmit image data or the like if the transmission processing unit receives a notification from the USB interface unit 401 of a detection of a connection with the PC in each modification, without waiting for a reception of a user instruction.

(11) In the above description of Embodiment 2, the transmission processing unit 213 of the digital camera 200 has a function to manage whether or not each piece of image data stored in the content storage unit 211 has been transmitted to the content classification device 300. However, not limited to this, the digital camera 200 and the content classification device 300 may be modified so that this management is performed by the content classification device 300.

More specifically, for example, the content classification device of this modification may request the digital camera of this modification to transmit a list of data numbers of image data stored in the content storage unit 211.

Upon receiving the request, the digital camera of this modification extracts the data numbers from the modified image information table, and transmits a list of the extracted data numbers to the content classification device of this modification.

Upon receiving the list of data numbers, the content classification device of this modification obtains the latest data number from the image information table 10 stored in the data storage unit 302, and judges whether or not the received list includes a data number that is equal to or greater than a sum of the latest data number and “1”.

If the content classification device of this modification judges that the received list includes a data number that is equal to or greater than a sum of the latest data number and “1”, which means that untransmitted image data is stored in the digital camera of this modification, the content classification device of this modification requests the digital camera of this modification to transmit image data associated with each data number that is equal to or greater than the sum of the latest data number and “1”.

Upon receiving the request, the digital camera of this modification transmits the requested image data (namely, untransmitted image data) and data numbers thereof, and records of the image data stored in the modified image information table, to the content classification device of this modification.

Upon receiving the image data and the like, the content classification device of this modification, as is the case with Embodiment 2, stores the received image data into the data storage unit 302, and registers the received records in the image information table 10.

(12) Part or all of the structural elements described in the Embodiments may be realized by an integrated circuit implemented on one chip or a plurality of chips, may be realized by a computer program, or may be realized in any other form.

Each structural element of the content generation classification device 110 in the Embodiments realizes its function when it operates in cooperation with the processor provided in the content generation classification device 110; and each structural element of the content classification device 300, 510, 552 realizes its function when it operates in cooperation with the processor provided in the content classification device 300, 510, 552.

(13) A program for causing a processor to execute the update process and classification process described in the Embodiments (see FIGS. 3, 4 and 12) may be recorded on a recording medium, and circulated and/or distributed via the recording medium, or may be circulated and/or distributed via various types of communication paths or the like. Such recording mediums include an IC card, optical disc, flexible disc, ROM, and flash memory. A program circulated and/or distributed is stored, for use, in a memory or the like that can be read by a processor provided in the device, and as the processor executes the program, each function of the content generation classification device and the content classification device described in the Embodiments is realized.

(14) Part or all of the above modifications (1) through (13) may be combined, for application, with a content classification system in the Embodiments.

(15) The following further describes the structure, modification, and effects of the content classification system, the content generation classification device, and content classification device in one embodiment of the present invention.

(a) A content classification system corresponding to one embodiment of the present invention is a content classification system provided with a content generating device for generating contents in sequence, the content classification system comprising: a detection unit operable to repeatedly detect a state of the content generating device, the state being a first state in which the content generating device is present at a predetermined position, or a second state in which the content generating device is not present at the predetermined position; and a classification unit operable to perform a classification process to classify two contents into different groups when there is a change in the state detected by the detection unit during a period between generations of the two contents by the content generating device, and classify the two contents into a same group when there is no change in the state detected by the detection unit during the period.

According to the above content classification system, two contents generated in an event A performed at a location other than the predetermined position can be classified into the same group. Also, a content generated in the event A and a content generated in an event B performed at the predetermined position can be classified into different groups.

That is to say, according to this content classification system, by setting, as the predetermined position, a place where the user with the content generating device is highly possible to be present during a period between two consecutive events, it is possible to increase the possibility to classify contents into events appropriately.

(b) In the above content classification system, the classification unit may perform the classification process onto each pair of contents continuously generated by the content generating device.

According to this content classification system, a plurality of contents generated in each event period can be classified into a same group, the event period being a period in which either a state in which the content generating device is present at a predetermined position, or a state in which the content generating device is not present at the predetermined position, continues.

Here, suppose a case where a user of this content generating device participates in events A and B that are performed in sequence. In that case, generally, it is highly possible that the user with the content generating device enters or exits the home after participating in the event A and before participating in the event B.

Accordingly, for example, by setting the predetermined position to the home of the user of the content generating device, it is possible to classify, into the same group, a plurality of contents generated in the event A performed for several consecutive days outside the home in which the user having exited the home together with the content generating device participated. Also, it is possible to classify, into a group that is differenct from the group for the event A, a plurality of contents generated in the event B which was performed in the home in which the user having entered back the home together with the content generating device participated, or the event B which was performed outside the home in which the user having entered back and then exited the home again together with the content generating device participated.

That is to say, the content generating device classifies generated contents into event periods, which, as a result, increases the possibility that the generated contents are classified into events appropriately.

(c) In the above content classification system, the content generating device may include: a first communication unit operable to transmit a first wireless signal receivable within a predetermined area; and a content storage unit storing one or more pieces of content information, each including a generated content and information indicating a time at which the content was generated, the content classification system further comprising a content classification device located at the predetermined position, the content classification device including: the detection unit; the classification unit; a second communication unit operable to receive the first wireless signal; and an obtaining unit operable to obtain the one or more pieces of content information stored in the content storage unit, the detection unit detecting the first state when the second communication unit receives the first wireless signal, and detecting the second state when the second communication unit does not receive the first wireless signal in a predetermined time period, and the classification process performed by the classification unit being a process in which contents constituting the one or more pieces of content information obtained by the obtaining unit are managed for each group to which the contents belong.

According to this content classification system, the content classification device detects the first state or the second state of the content generating device, depending on whether or not the first wireless signal is received, where the first wireless signal can be received by the content classification device only when the content generating device is within a predetermined area set around the content classification device.

Thus, by setting the predetermined area to a relatively narrow area, it is possible to detect the state of the content generating device appropriately and increase the possibility to classify contents into events appropriately.

(d) In the above content classification system, the second communication unit may further be operable to repeatedly transmit a second wireless signal receivable within the predetermined area, the first communication unit may further be operable to receive the second wireless signal, and transmit the first wireless signal upon receiving the second wireless signal, and the second communication unit may measure the predetermined time with reference to a time at which the second communication unit transmits the second wireless signal.

According to this content classification system, the first wireless signal is transmitted by the content generating device when the content generating device is within a predetermined area set around the content classification device. Thus, by setting the predetermined area to a relatively narrow area, it is possible to detect whether the content generating device is in the first state or the second state appropriately and increase the possibility to classify contents into events appropriately.

(e) In the above content classification system, the first communication unit may be an IC tag that repeatedly transmits, as the first wireless signal, a signal including identification information of the content generating device, and the second communication unit may be an IC tag reader.

According to this content classification system, it is possible to detect whether the content generating device is in the first state or the second state appropriately by using an existing mechanism including an IC tag and an IC tag reader, making it relatively easy for the content classification system to be implemented.

(f) In the above content classification system, the content generating device may include: the detection unit; the classification unit; and a receiving unit operable to receive a predetermined wireless signal, and the detection unit may detect the state of the content generating device based on the predetermined wireless signal received by the receiving unit.

According to this content classification system, the content generating device, which generates contents, classifies the contents as well, thus it is possible for one device to perform the processes from generation to classification of contents all at once consistently.

(g) In the above content classification system, the predetermined wireless signal may be a signal transmitted from a GPS (Global Positioning System) satellite, the content generating device may further include: a position storage unit storing position information indicating a latitude and a longitude of the predetermined position; and a position obtaining unit operable to calculate a latitude and a longitude of a position of the content generating device, based on the predetermined wireless signal received by the receiving unit, the detection unit detecting the first state when a difference between the latitude and the longitude indicated by the position information stored in the position storage unit and the latitude and the longitude calculated by the position obtaining unit is equal to or smaller than a predetermined value, and detecting the second state when the difference is greater than the predetermined value.

According to this content classification system, it is possible to detect whether the content generating device is in the first state or the second state appropriately by using an existing mechanism of GPS, making it relatively easy for the content classification system to be implemented.

(h) In the above content classification system, the content generating device may further include: a content storage unit storing one or more pieces of content information, each including a generated content and information indicating a time at which the content was generated, the content classification system further comprising a content management device located at the predetermined position, the content management device including: a transmission unit operable to repeatedly transmit the predetermined wireless signal; and an obtaining unit operable to obtain the one or more pieces of content information stored in the content storage unit, the predetermined wireless signal being receivable only within a predetermined area, the detection unit detecting the first state when the receiving unit receives the predetermined wireless signal, and detecting the second state when the receiving unit does not receive the predetermined wireless signal in a predetermined time period, and the classification process performed by the classification unit being a process in which contents constituting the one or more pieces of content information obtained by the obtaining unit are managed for each group to which the contents belong.

According to this content classification system, the content generating device detects whether the content generating device itself is in the first state or the second state, depending on whether or not a wireless signal is received, where the wireless signal can be received only when the content generating device itself is within a predetermined area set around the content management device.

Thus, by setting the predetermined area to a relatively narrow area, it is possible to detect the state of the content generating device appropriately and increase the possibility to classify contents into events appropriately.

(i) The above content classification system may further comprise: a content classification device located at the predetermined position, the content classification device including: the detection unit; and the classification unit, each of the content generating device and the content classification device including a connection unit operable to connect, by a wired connection, the content generating device or the content classification device to another device, the detection unit detecting the first state when the detection unit detects the wired connection by the connection unit of the content classification device, and detecting the second state when the detection unit does not detect the wired connection in a predetermined time period.

According to this content classification system, by making a wired connection using a cable as short as, for example, several meters, it is possible to detect whether the content generating device is in the first state or the second state appropriately and increase the possibility to classify contents into events appropriately.

(j) In the above content classification system, the content generating device may be a digital camera operable to capture images of objects and generate image data, and the content classification device may be a computer located at a home of a user owning the digital camera.

According to this content classification system, it is possible to classify, into the same group, a plurality of pieces of image data of images captured in the event A performed for several consecutive days outside the home while the user with the content generating device (the digital camera) exited the home and participated in the event A. Also, a plurality of pieces of image data of images captured by the user, who entered back the home together with the content generating device, in an event B performed at the home are classified into a group that is differenct from the group for the event A.

(k) The above content classification system may further comprise a content classification device and a plurality of content generating devices, the content classification device being located at the predetermined position, the content classification device including: the detection unit; and the classification unit, and the detection unit detecting the state of each of the content generating devices, and the classification unit performing the classification process for each of the content generating devices.

According to this content classification system, by setting, as the predetermined position, a place where a plurality of users of a plurality of content generating devices are highly possible to be in common, it is possible to increase the possibility to classify contents into events for each content generating device appropriately.

For example, when members of a family (father, mother, son, and daughter) are the plurality of users of the plurality of content generating devices, the predetermined position can be set to the home of the family. As another example, when students of a school are the plurality of users of the plurality of content generating devices, the predetermined position can be set to a classroom of the school, or when workers of a company are the plurality of users of the plurality of content generating devices, the predetermined position can be set to an office of the company.

(1) A content generation classification device corresponding to one embodiment of the present invention is a content generation classification device comprising: a content storage unit storing contents; a generating unit operable to generate contents in sequence and store the generated contents into the content storage unit; a detection unit operable to repeatedly detect a state of the content generation classification device, the state being a first state in which the content generation classification device is present at a predetermined position, or a second state in which the content generation classification device is not present at the predetermined position; and a classification unit operable to perform a classification process to classify two contents stored in the content storage unit into different groups when there is a change in the state detected by the detection unit during a period between generations of the two contents, and classify the two contents into a same group when there is no change in the state detected by the detection unit during the period.

According to the above content generation classification device, two contents generated in an event A performed at a location other than the predetermined position can be classified into the same group. Also, a content generated in the event A and a content generated in an event B performed at the predetermined position can be classified into different groups.

That is to say, according to this content generation classification device, by setting, as the predetermined position, a place where the user with the content generation classification device is highly possible to be present during a period between two consecutive events, it is possible to increase the possibility to classify contents into events appropriately.

(m) The above content generation classification device may further comprise: a position storage unit storing position information indicating a latitude and a longitude of the predetermined position; and a position calculation unit operable to calculate, by using a GPS, a latitude and a longitude of a position of the content generation classification device, the detection unit detecting the first state when a difference between the latitude and the longitude indicated by the position information stored in the position storage unit and the latitude and the longitude calculated by the position calculation unit is equal to or smaller than a predetermined value, and detecting the second state when the difference is greater than the predetermined value.

According to this content generation classification device, it is possible to detect whether the content generation classification device itself is in the first state or the second state appropriately by using an existing mechanism of GPS, making it relatively easy for the content generation classification device to be implemented.

(n) A content classification device corresponding to one embodiment of the present invention is a content classification device comprising: a content storage unit storing contents generated in sequence by an external device; a detection unit operable to repeatedly detect a state of the external device, the state being a first state in which the external device is present at a predetermined position, or a second state in which the external device is not present at the predetermined position; and a classification unit operable to perform a classification process to classify two contents into different groups when there is a change in the state detected by the detection unit during a period between generations of the two contents by the external device, and classify the two contents into a same group when there is no change in the state detected by the detection unit during the period.

According to the above content classification device, two contents generated in an event A performed at a location other than the predetermined position can be classified into the same group. Also, a content generated in the event A and a content generated in an event B performed at the predetermined position can be classified into different groups.

That is to say, according to this content classification device, by setting, as the predetermined position, a place where the user with the external device is highly possible to be present during a period between two consecutive events, it is possible to increase the possibility to classify contents into events appropriately.

(16) A classification method of the present invention is realized by, for example, the content generation classification device 110, or content classification device 300, 510, or 552 described in the above Embodiments (see, in particular, the procedure of the classification process described with reference to FIG. 4 or FIG. 12).

### INDUSTRIAL APPLICABILITY

The content classification system, content generation classification device, and content classification device of the present invention can be used to automatically classfy a plurality of contents.

### REFERENCE SIGNS LIST

1 USB cable
100, 200, 400, 450 digital camera
101 release button
102, 303 display unit
103 time measuring unit
110 content generation classification device
111 storage unit
112 position storage unit
113 generating unit
114 image capturing unit
115 image capturing control unit
116 position calculating unit
117, 304, 512, 553 detection unit
118, 306 classification unit
119, 307 time information update unit
120, 308 classification processing unit
210, 410, 451 content generating device
211 content storage unit
212, 301 wireless communication unit
213, 412 transmission processing unit
300, 510, 552 content classification device
302 data storage unit
305, 513 obtaining unit
401, 501, 551 USB interface unit
411 IC tag
500, 550 PC
511 IC tag reader
1000, 1100, 1200 content classification system

1. A content classification system provided with a content generating device for generating contents in sequence, the content classification system comprising:
a detection unit operable to repeatedly detect a state of the content generating device, the state being a first state in which the content generating device is present at a predetermined position, or a second state in which the content generating device is not present at the predetermined position; and
a classification unit operable to perform a classification process to classify two contents into different groups when there is a change in the state detected by the detection unit during a period between generations of the two contents by the content generating device, and classify the two contents into a same group when there is no change in the state detected by the detection unit during the period.

2. The content classification system of claim 1, wherein
the classification unit performs the classification process onto each pair of contents continuously generated by the content generating device.

3. The content classification system of claim 2, wherein
the content generating device includes:
a first communication unit operable to transmit a first wireless signal receivable within a predetermined area; and
a content storage unit storing one or more pieces of content information, each including a generated content and information indicating a time at which the content was generated,
the content classification system further comprising
a content classification device located at the predetermined position, the content classification device including:
the detection unit;
the classification unit;
a second communication unit operable to receive the first wireless signal; and
an obtaining unit operable to obtain the one or more pieces of content information stored in the content storage unit,
the detection unit detecting the first state when the second communication unit receives the first wireless signal, and detecting the second state when the second communication unit does not receive the first wireless signal in a predetermined time period, and
the classification process performed by the classification unit being a process in which contents constituting the one or more pieces of content information obtained by the obtaining unit are managed for each group to which the contents belong.

4. The content classification system of claim 3, wherein
the second communication unit is further operable to repeatedly transmit a second wireless signal receivable within the predetermined area,
the first communication unit is further operable to receive the second wireless signal, and transmit the first wireless signal upon receiving the second wireless signal, and
the second communication unit measures the predetermined time with reference to a time at which the second communication unit transmits the second wireless signal.

5. The content classification system of claim 3, wherein
the first communication unit is an IC tag that repeatedly transmits, as the first wireless signal, a signal including identification information of the content generating device, and
the second communication unit is an IC tag reader.

6. The content classification system of claim 2, wherein
the content generating device includes:
the detection unit;
the classification unit; and
a receiving unit operable to receive a predetermined wireless signal, and
the detection unit detects the state of the content generating device based on the predetermined wireless signal received by the receiving unit.

7. The content classification system of claim 6, wherein
the predetermined wireless signal is a signal transmitted from a GPS (Global Positioning System) satellite,
the content generating device further includes:
a position storage unit storing position information indicating a latitude and a longitude of the predetermined position; and
a position obtaining unit operable to calculate a latitude and a longitude of a position of the content generating device, based on the predetermined wireless signal received by the receiving unit,
the detection unit detecting the first state when a difference between the latitude and the longitude indicated by the position information stored in the position storage unit and the latitude and the longitude calculated by the position obtaining unit is equal to or smaller than a predetermined value, and
detecting the second state when the difference is greater than the predetermined value.

8. The content classification system of claim 6, wherein
the content generating device further includes:
a content storage unit storing one or more pieces of content information, each including a generated content and information indicating a time at which the content was generated,
the content classification system further comprising
a content management device located at the predetermined position,
the content management device including:
a transmission unit operable to repeatedly transmit the predetermined wireless signal; and
an obtaining unit operable to obtain the one or more pieces of content information stored in the content storage unit,
the predetermined wireless signal being receivable only within a predetermined area,
the detection unit detecting the first state when the receiving unit receives the predetermined wireless signal, and detecting the second state when the receiving unit does not receive the predetermined wireless signal in a predetermined time period, and
the classification process performed by the classification unit being a process in which contents constituting the one or more pieces of content information obtained by the obtaining unit are managed for each group to which the contents belong.

9. The content classification system of claim 2 further comprising:
a content classification device located at the predetermined position,
the content classification device including:
the detection unit; and
the classification unit,
each of the content generating device and the content classification device including a connection unit operable to connect, by a wired connection, the content generating device or the content classification device to another device,
the detection unit detecting the first state when the detection unit detects the wired connection by the connection unit of the content classification device, and detecting the second state when the detection unit does not detect the wired connection in a predetermined time period.

10. The content classification system of claim 2, wherein
the content generating device is a digital camera operable to capture images of objects and generate image data, and
the content classification device is a computer located at a home of a user owning the digital camera.

11. The content classification system of claim 2 further comprising
a content classification device and a plurality of content generating devices,
the content classification device being located at the predetermined position,
the content classification device including:
the detection unit; and
the classification unit, and
the detection unit detecting the state of each of the content generating devices, and the classification unit performing the classification process for each of the content generating devices.

12. A content generation classification device comprising:
a content storage unit storing contents;
a generating unit operable to generate contents in sequence and store the generated contents into the content storage unit;
a detection unit operable to repeatedly detect a state of the content generation classification device, the state being a first state in which the content generation classification device is present at a predetermined position, or a second state in which the content generation classification device is not present at the predetermined position; and
a classification unit operable to perform a classification process to classify two contents stored in the content storage unit into different groups when there is a change in the state detected by the detection unit during a period between generations of the two contents, and classify the two contents into a same group when there is no change in the state detected by the detection unit during the period.

13. The content generation classification device of claim 12 further comprising:
a position storage unit storing position information indicating a latitude and a longitude of the predetermined position; and
a position calculation unit operable to calculate, by using a GPS, a latitude and a longitude of a position of the content generation classification device,
the detection unit detecting the first state when a difference between the latitude and the longitude indicated by the position information stored in the position storage unit and the latitude and the longitude calculated by the position calculation unit is equal to or smaller than a predetermined value, and
detecting the second state when the difference is greater than the predetermined value.

14. A content classification device comprising:
a content storage unit storing contents generated in sequence by an external device;
a detection unit operable to repeatedly detect a state of the external device, the state being a first state in which the external device is present at a predetermined position, or a second state in which the external device is not present at the predetermined position; and
a classification unit operable to perform a classification process to classify two contents into different groups when there is a change in the state detected by the detection unit during a period between generations of the two contents by the external device, and classify the two contents into a same group when there is no change in the state detected by the detection unit during the period.

15. A classification method for use in a content classification system provided with a content generating device for generating contents in sequence, the classification method comprising the steps of:
repeatedly detecting a state of the content generating device, the state being a first state in which the content generating device is present at a predetermined position, or a second state in which the content generating device is not present at the predetermined position; and
classifying two contents into different groups when there is a change in the state detected in the detecting step during a period between generations of the two contents by the content generating device, and classifying the two contents into a same group when there is no change in the state detected in the detecting step during the period.

16. A program for causing a computer, which is included in a content classification system provided with a content generating device for generating contents in sequence, to perform a classification process, the program comprising the steps of:
repeatedly detecting a state of the content generating device, the state being a first state in which the content generating device is present at a predetermined position, or a second state in which the content generating device is not present at the predetermined position; and
classifying two contents into different groups when there is a change in the state detected in the detecting step during a period between generations of the two contents by the content generating device, and classifying the two contents into a same group when there is no change in the state detected in the detecting step during the period.
